(19) United States
(12) Patent Application Publication
(10) Pub. No.: US 2018/0269507 A1
(43) Pub. Date: Sep. 20, 2018

(54) NANOFIBER MATS, MAKING METHODS AND APPLICATIONS OF SAME

(71) Applicant: Vanderbilt University, Nashville, TN (US)

(72) Inventors: Peter N. Pintauro, Nashville, TN (US); Matthew Brodt, Nashville, TN (US)

(21) Appl. No.: 15/764,481

(22) PCT Filed: Oct. 3, 2016
(86) PCT No.: PCT/US2016/055139

§ 371 Date: Mar. 29, 2018

Related U.S. Application Data
(60) Provisional application No. 62/236,600, filed on Oct. 2, 2015.

(51) Int. Cl. H01M 8/1004; H01M 4/88; H01M 4/86; H01M 4/92; H01M 8/1018; D04H 1/728

(52) U.S. Cl. CPC H01M 8/1004; H01M 4/8875; H01M 4/8896; H01M 4/8668; H01M 4/926; H01M 2300/0082; H01M 4/8807; H01M 8/1018; D04H 1/728; H01M 2008/1095; H01M 4/921

(57) ABSTRACT

A method of forming a membrane-electrode-assembly (MEA) for an electrochemical device. The method includes providing a first solution formed by mixing a Pt/C catalyst, Nafion® and PVDF, and a second solution formed by mixing Pt/C catalyst, Nafion® and PPA; electrospinning respectively the first solution and the second solution to form a first nanofiber mat and a second nanofiber mat; pressing the first nanofiber mat and the second nanofiber mat on opposite sides of a polymer electrolyte membrane to form a catalyst coated membrane (CCM); and pressing a carbon gas diffusion layer on each of the cathode and the anode of the CCM to form the MEA.

### CROSS-REFERENCE TO RELATED PATENT APPLICATIONS

This PCT application claims priority to and the benefit of, pursuant to 35 U.S.C. § 119(e), U.S. provisional patent application Ser. No. 62/236,600, filed Oct. 2, 2015, which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference. In terms of notation, hereinafter, “[n]” represents the nth reference cited in the reference list. For example, [1] represents the first reference cited in the reference list, namely, Litster, S. and G. McLean, PEM fuel cell electrodes. Journal of Power Sources, 2004. 130(1-2): p. 61-76.

### STATEMENT AS TO RIGHTS UNDER FEDERALLY-SPONSORED RESEARCH

This invention was made with government support under Contract No. EPS-1004083 awarded by the National Science Foundation. The government has certain rights in the invention.

### FIELD OF THE INVENTION

The present invention relates generally to nanotechnologies, and more particularly to nanofiber mats, making methods and applications of the nanofiber mats.

### BACKGROUND OF THE INVENTION

Fossil fuels are currently the predominant source of energy in the world. Due to concerns such as carbon dioxide emissions and the finite nature of the supply of fossil fuel, research and development and commercialization of alternative sources of energy have grown significantly over the preceding decades.

The hydrogen/air proton-exchange membrane fuel cell is a promising candidate for emission-free automotive power plants, but issues remain regarding the high cost and problematic durability of membrane-electrode-assemblies (MEAs) [1]. For commercialization, the platinum (Pt) loading of fuel cell MEAs (particularly the cathode) must be reduced while maintaining high power output and the catalytic activity of the cathode for electrochemical oxygen reduction must be maintained during long-term operation with various power cycles and numerous stack start-ups and shut-downs [2].

Therefore, a heretofore unaddressed need exists in the art to address the aforementioned deficiencies and inadequacies.

### SUMMARY OF THE INVENTION

In one aspect, the present invention relates to a method of forming a membrane-electrode-assembly (MEA) for an electrochemical device. In certain embodiments, the method includes:

providing a first solution and a second solution, wherein the first solution comprises a first catalyst, at least one first charged polymer, and at least one first uncharged polymer, and wherein the second solution comprises a second catalyst, at least one second charged polymer, and at least one second functional polymer;

electrospinning the first solution and the second solution to form a first nanofiber mat and a second nanofiber mat, respectively;

providing a membrane having a first side and an opposite, second side;

pressing the first nanofiber mat on the first side of the membrane as a cathode, and pressing the second nanofiber mat on the second side of the membrane as an anode, so as to form a catalyst coated membrane (CCM); and processing the CCM to form the MEA.

In certain embodiments, the at least one first uncharged polymer has a repeat unit having a formula of

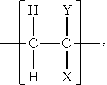

and each of X and Y is a non-hydroxyl group.

In certain embodiments, the first solution further comprises as least one first functional polymer to assist electro spinning of the first solution, or to improve at least one property of the cathode.

In certain embodiments, each of the first catalyst and the second catalyst is a platinum/carbon (Pt/C) catalyst or a Pt-alloy catalyst.

In certain embodiments, at least one of the first solution and the second solution is selected from: a composition comprising Pt/Co catalyst, a perfluorosulfonic acid (PFSA) polymer, and poly(acrylic acid) (PAA); a composition comprising Pt/Ni catalyst, a PFSA polymer, and PAA; a composition comprising Pt/Co catalyst, a PFSA polymer, and poly(vinylidene fluoride) (PVDF); or a composition comprising Pt/Ni catalyst, a PFSA polymer, and PVDF.

In certain embodiments, the PFSA polymer is Nafion®.

In certain embodiments, catalyst loading in the cathode and the anode is in a range of about 0.10-0.50 mg/cm².

In certain embodiments, the membrane is a perfluorosulfonic acid membrane like Nafion® 211 membrane.

In certain embodiments, each of the at least one first charged polymer and the at least one second charged polymer is a PFSA polymer or a perfluoroimide-acid (PFIA) polymer. In certain embodiments, each of the at least one first charged polymer and the at least one second charged polymer is Nafion®. In certain embodiments, the at least one first uncharged polymer is poly(vinylidene fluoride) (PVDF), and the second functional polymer is PAA.

In certain embodiments, an amount of the PVDF in the first solution is in a range of about 20%-80% by weight of a total amount of the Nafion® and the PVDF in the first solution.

In certain embodiments, the first catalyst is platinum/carbon (Pt/C) catalyst, and the first solution is formed by: wetting the first catalyst with dimethylformamide (DMF) to form a first mixture; adding tetrahydrofuran (THF) to the first mixture to form a second mixture; adding Nafion® to the second mixture to form a third mixture and sonicating the third mixture; and adding PVDF to the third mixture, and stirring to form the first solution.

In certain embodiments, the second catalyst is Pt/C catalyst, and the second solution is formed by: wetting the second catalyst with water to form a fourth mixture; adding isopropanol (IPA) to the fourth mixture to form a fifth mixture; adding Nafion® to the fifth mixture to form a sixth mixture and sonicating the sixth mixture; and adding PAA to the sixth mixture, and stirring to form the second solution.

In certain embodiments, the steps of processing the CCM to form the MEA comprises: pressing a carbon gas diffusion layer on each of the cathode and the anode of the CCM.

In one aspect, the present invention relates to a fuel cell having the MEA described above.

In one aspect, the present invention relates to a membrane-electrode-assembly (MEA) for an electrochemical device. The MEA includes:

a polymer electrolyte membrane having a first side and an opposite, second side;

a cathode of a first nanofiber mat attached to the first side of the polymer electrolyte membrane, wherein the first nanofiber mat is formed of a first catalyst, at least one first charged polymer and at least one first uncharged polymer; and

an anode of a second nanofiber mat attached to the second side of the polymer electrolyte membrane, wherein the second nanofiber mat is formed of a second catalyst, at least one second charged polymer and at least one second functional polymer.

In certain embodiments, the first uncharged polymer has a repeat unit having a formula of

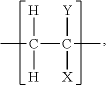

and each of X and Y is a non-hydroxyl group.

In certain embodiments, the first nanofiber mat is formed of, in addition to the first catalyst, the at least one first charged polymer and the at least one first uncharged polymer, at least one first functional polymer, and the first functional polymer is capable of assisting electro spinning to form the first nanofiber mat, or is capable of improving at least one property of the cathode.

In certain embodiments, the MEA further includes a first carbon gas diffusion layer disposed on an outer surface of the cathode and a second carbon gas diffusion layer disposed on an outer surface of the anode.

In certain embodiments, each of the at least one first charged polymer and the at least one second charged polymer is a perfluorosulfonic acid ionomer or a perfluoroimide-acid polymer (PFIA) ionomer.

In certain embodiments, the at least one first charged polymer and the at least one second charged polymer are Nafion®.

In certain embodiments, the first catalyst and the second catalyst are platinum/carbon (Pt/C) catalyst, the polymer electrolyte membrane is a Nafion® 211 membrane, the at least one first uncharged polymer is poly(vinylidene fluoride) (PVDF) or a copolymer thereof, and the second functional polymer is poly(acrylic acid) (PAA) which functions as a carrier for electro spinning.

In certain embodiments, an amount of the PVDF in the cathode is in a range of about 20%-80% by weight of a total amount of the Nafion® and the PVDF in the cathode.

In certain embodiments, Pt loading in the cathode and the anode is in a range of about 0.10-0.50 mg/cm².

In certain embodiments, at least one of the first nanofiber mat and the second nanofiber mat comprises Pt/Co catalyst, a PFSA polymer, and PAA; Pt/Ni catalyst, a PFSA polymer, and PAA; Pt/Co catalyst, a PFSA polymer, and PVDF; or Pt/Ni catalyst, a PFSA polymer, and PVDF.

In certain embodiments, the PFSA polymer is Nafion®.

In one aspect, the present invention relates to a fuel cell having the MEA described above.

In one aspect, the present invention relates to a method of forming a membrane-electrode-assembly (MEA) for an electrochemical device. In certain embodiments, the method includes:

providing a first ink and a second ink, wherein the first ink is formed by mixing Nafion® and poly(ethylene oxide (PEO) in a 2:1 n-propanol/water solution, and the second ink is formed by mixing Pt/C catalyst and PVDF in a 3:7 DMF/acetone solution;

electrospinning, separately and simultaneously, the first ink and the second ink to form a dual fiber mat comprising first polymer fibers formed from the first ink and second polymer fibers formed from the second ink;

annealing the dual fiber mat at about 150° C. for about 1 hour in vacuum, and heating at about 140° C. for about 10 minutes in vacuum;

pressing the annealed and heated dual fiber mat to opposing sides of a Nafion® 211 membrane at about 140° C. for about 1 minutes under 4 MPa as cathode and anode to form CCM;

treating the CCM using 1M sulfuric acid for 1 hour so as to extract the PEO; and

pressing a carbon gas diffusion layer on each of the cathode and the anode to form the MEA.

In certain embodiments, a ratio between an amount of the Nafion® and the PEO is about 100:1 by weight, and a ratio between an amount of the catalyst and an amount of the PVDF is about 3:1 by weight.

In certain embodiments, a Pt loading in the cathode and the anode is in a range of about 0.10 mg/cm²-0.50 mg/cm².

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 shows schematically a membrane-electrode-assembly (MEA) according to one embodiment of the present invention.

FIG. 2 shows a flowchart of forming an MEA according to one embodiment of the present invention.

FIG. 3A shows a top-down 6,000× scanning electron microscope (SEM) images of an electrospun Pt/C-PVDF nanofiber mat (fiber composition: 70 wt % Pt/C powder and 30 wt % PVDF).

FIG. 3B shows a top-down 6,000×SEM images of an electrospun Pt/C-Nafion®/PVDF nanofiber mat with a binder of 80/20 Nafion®/PVDF w/w (fiber composition: 70 wt % Pt/C powder, 24 wt % Nafion®, and 6 wt % PVDF).

FIG. 4 shows beginning-of-life (BoL) polarization curves for 5 cm² MEAs with a Nafion® 211 membrane, a 0.10 mg_{Pt}/cm² electrospun cathode and a 0.10 mg_{Pt}/cm² electrospun anode. Fuel cell operating conditions are: 80° C., 125 sccm H₂ and 500 sccm air at ambient pressure and 100% RH. The cathode binder (w/w) is: (●) Nafion®/PAA (67/33), (▴) Nafion®/PVDF (80/20), or (▪) PVDF.

FIGS. 5A and 5B show polarization curves for MEAs with electrospun Nafion®/PVDF cathodes (solid lines) and an MEA with a conventional painted GDE cathode with 70 wt % Pt/C and 30 wt % Nafion® (dashed line). The electrospun cathode Nafion®/PVDF w/w are: (1) 80/20, (2) 67/33, (3) 50/50, (4) 33/67, (5) 20/80, and (6) 0/100. All MEAs are 5 cm² and contain a Nafion® 211 membrane and 0.10 mg_{Pt}/cm² at the cathode and anode. Fuel cell operating conditions are 80° C., 125 sccm H₂ and 500 sccm air at ambient pressure and 100% RH. FIG. 5A shows the BoL data, and FIG. 5B shows the end-of-life (EoL) data.

FIGS. 6A-6F show BoL (solid symbols) and EoL (open symbols) polarization curves for 5 cm² MEAs with a Nafion® 211 membrane and 0.10 mg_{Pt}/cm² cathode and anode after 1,000 voltage cycles. Fuel cell operating conditions are: 80° C., 100% RH, 125 sccm H₂ and 500 sccm air at ambient pressure. Each plot shows data for an MEA with a nanofiber cathode (triangles) and an MEA with a painted GDE cathode (circles) with the same Nafion®/PVDF cathode composition, where the Nafion®/PVDF cathode compositions are respectively 80/20, 67/33, 50/50, 33/67, 20/80, and 0/100 for FIGS. 6A-6F.

FIGS. 7A and 7B show real time measurement of CO₂ in the cathode exhaust during a carbon corrosion potential cycling experiment at 100% RH, where FIG. 7A shows that of three nanofiber MEAs, and FIG. 7B shows that of Nafion® GDE MEA and a Nafion®/PVDF MEA.

FIG. 8 shows cumulative cathode carbon loss after 1,000 cycles for nanofiber and painted GDE MEAs with Nafion®/PVDF binder as a function of PVDF binder content.

FIG. 9 shows relative cathode ECA loss vs. cathode carbon loss after an accelerated carbon corrosion voltage cycling test (1,000 cycles; 1.0 to 1.5V for this work).

FIGS. 10A and 10B show power densities at 0.65 V for MEAs with either an electrospun cathode (FIG. 10A) or a painted GDE cathode (FIG. 10B) as a function of voltage cycle number. MEAs have 0.10 mg_{Pt}/cm² cathodes and anodes. Fuel cell operating conditions are: 80°, fully humidified 125 sccm H₂ and 500 sccm air at ambient pressure.

FIGS. 11A and 11B show polarization curves for MEAs at 40% RH with electrospun Nafion®/PVDF cathodes (solid lines) and an MEA with a conventional GDE cathode containing 70 wt % Pt/C and 30 wt % Nafion® (dashed line). The electrospun cathode Nafion®/PVDF w/w are: (1) 80/20, (2) 67/33, (3) 50/50, (4) 33/67, (5) 20/80, and (6) 0/100. All MEAs are 5 cm² and contain a Nafion® 211 membrane and 0.10 mg_{Pt}/cm² at the cathode and anode. Fuel cell operating conditions are 80° C., 40% RH, 125 sccm H₂ and 500 sccm air at ambient pressure. FIG. 11A shows BoL data, and FIG. 11B shows EoL data.

FIGS. 12A and 12B show power densities at 0.65 V at BoL (solid symbols) and EoL (open symbols) of MEAs as a function of PVDF wt % in the cathode binder (the remaining wt % is Nafion®, except in the nanofiber case at 0% PVDF, where the binder is 67 wt. % Nafion® and 33 wt. % PAA). The cathodes have a Pt loading of 0.10 mg/cm² and are either electrospun (triangles) or painted GDEs (circles). For all MEAs, a nanofiber 0.10 mg/cm² anode was used with a 67 wt % Nafion® and 33 wt % PAA binder. Fuel cell operating conditions are: 80°, 125 sccm H₂ and 500 sccm air at ambient pressure at either 100% RH (FIG. 12A), or 40% RH (FIG. 12B).

FIGS. 13A and 13B show nanofiber electrode fuel cell performance with a Nafion®/PAA binder.

FIGS. 14A and 14B show initial FC Performance of nanofiber cathode vs Nissan sprayed GDE.

FIGS. 15A and 15B show comparison of nanofiber and sprayed electrode MEAs based on beginning and end of life FC performance.

FIGS. 16A and 16B show comparison of nanofiber and sprayed MEAs based on beginning and end of life FC Performance.

FIGS. 17A and 17B show end of life FC Performance after Start-Stop Cycling.

FIG. 18 shows comparison of PVDF as a binder and Nafion®/PAA as a binder.

FIG. 19 shows comparison of Nafion®/PAA and PVDF as the cathode binder based on the FC performance before/after carbon corrosion test.

FIGS. 20A-20D show PVDF and Nafion®/PVDF as cathode binders for Pt/C nanofibers.

FIG. 21 shows FC Performance with PVDF, Nafion®/PVDF, and Nafion®/PAA binders.

FIGS. 22A and 22B show BoL and EoL power for Nafion®/PVDF binders.

FIGS. 23A and 23B show PtCo nanofiber vs. GDE cathode, where the catalyst is PtCo on acetylene black (5 wt. % Co).

FIGS. 24A and 24B show comparison of Johnson-Matthey Pt/C vs. PtCo nanofiber cathodes.

FIG. 25 shows a top-down 3,000×SEM image of a dual electrospun fiber mat with (i) fibers composed of Pt/C catalyst particles with a binder of PVDF (75 wt % P/C, 25 wt % PVDF) and (ii) fibers composed for Nafion®/PEO (99 wt % Nafion®, 1 wt % PEO).

FIG. 26 shows a polarization curve for a 5 cm² dual electrospun cathode MEA with a Nafion® 211 membrane and cathode and anode Pt loading of 0.10 mg/cm² with Johnson Matthey HiSpec 4000 catalyst. Fuel cell operating conditions: 80° C., 100% RH feed gases at ambient pressure, 125 sccm H2 and 500 sccm air.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term are the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, “plurality” means two or more.

The terms “proton exchange membrane” or its abbreviation “PEM”, as used herein, refer to a composite membrane generally made from ionomers and designed to conduct protons. The terms “proton exchange membrane fuel cell” or “PEM fuel cell”, or its abbreviation “PEMFC”, refer to a fuel cell using the PEM.

The terms “anion exchange membrane” or its abbreviation “AEM”, as used herein, refer to a composite membrane generally made from ionomers and designed to conduct anions. The terms “anion exchange membrane fuel cell” or “AEM fuel cell”, or its abbreviation “AEMFC”, refer to a fuel cell using the AEM.

As used herein, the term “melt” refers to a transitional process of a substance from a solid state to a fluid-like state, such as liquid or gel. Specifically, the melting process in this disclosure refers to softening and flowing of the substance, and may be induced by pressure, temperature, other chemically inducing substances such as a solvent, or a combination thereof. Thus, melting of the substance, as used herein, is not limited to the physical phase transition of the substance from the solid state to the liquid state, and does not necessarily require elevated temperature or pressure.

As used herein, the term “conducting polymer” or “ionomer” generally refers to a polymer that conducts ions. More precisely, the ionomer refers to a polymer that includes repeat units of at least a fraction of ionized units. As used herein, the term “polyelectrolyte” generally refers to a type of ionomer, and particularly a polymer whose repeating units bear an electrolyte group, which will dissociate when the polymer is exposed to aqueous solutions (such as water), making the polymer charged. The conducting polymers, ionomers and polyelectrolytes may be generally referred to as “charged polymers”. As used herein, the terms “polyelectrolyte fiber” or “charged polymer fiber” generally refer to the polymer fiber formed by polyelectrolytes or the likes. As used herein, polyelectrolyte, ionomer, and charged polymer can be used interchangeably.

As used herein, the terms “uncharged polymer” or “uncharged (or minimally charged) polymer” generally refer to the polymer that does not effectively conduct ions, particularly to the polymer whose repeating units do not bear an ionizable group or bear a small number of ionizable groups, and thus the polymer will not be charged or will have a very small charge when being exposed to aqueous solutions. As used herein, the terms “uncharged polymer fiber” or “uncharged (or minimally charged) polymer fiber” generally refer to the polymer fiber formed by the uncharged/uncharged (or minimally charged) polymer.

As used herein, if any, the term “scanning electron microscope” or its abbreviation “SEM” refers to a type of electron microscope that images the sample surface by scanning it with a high-energy beam of electrons in a raster scan pattern. The electrons interact with the atoms that make up the sample producing signals that contain information about the sample's surface topography, composition and other properties such as electrical conductivity.

As used herein, “nanoscopic-scale”, “nanoscopic”, “nanometer-scale”, “nanoscale”, “nanocomposites”, “nanoparticles”, the “nano-” prefix, and the like generally refers to elements or articles having widths or diameters of less than about 1 μm, preferably less than about 300 nm in some cases. In all embodiments, specified widths can be smallest width (i.e. a width as specified where, at that location, the article can have a larger width in a different dimension), or largest width (i.e. where, at that location, the article's width is no wider than as specified, but can have a length that is greater).

As used herein, a “nanostructure” refers to an object of intermediate size between molecular and microscopic (micrometer-sized) structures. In describing nanostructures, the sizes of the nanostructures refer to the number of dimensions on the nanoscale. For example, nanotextured surfaces have one dimension on the nanoscale, i.e., only the thickness of the surface of an object is between 0.1 and 1000 nm. A list of nanostructures includes, but not limited to, nanoparticle, nanocomposite, quantum dot, nanofilm, nanoshell, nanofiber, nanoring, nanorod, nanowire, nanotube, nanocapillary structures, and so on.

The description is now made as to the embodiments of the invention in conjunction with the accompanying drawings. In accordance with the purposes of this invention, as embodied and broadly described herein, this invention, in one aspect, relates to nanofiber mats, making methods and applications of the nanofiber mats. Although various exemplary embodiments of the present invention disclosed herein may be described in the context of fuel cells, it should be appreciated that aspects of the present invention disclosed herein are not limited to being used in connection with one particular type of fuel cell such as a proton exchange membrane (PEM) fuel cell and may be practiced in connection with other types of fuel cells or other types of electrochemical devices such as capacitors and/or batteries without departing from the scope of the present invention disclosed herein.

The present invention relates to composite membranes, such as nanofiber-based membranes, PEMs or AEMs, formed by a mat of dual or multi nanofibers, methods of making the same, and corresponding applications, where one or more ion conducting polymer nanofibers and one or more charged or uncharged polymers forms the network of the composite membranes, where one or more of the fibers are softened and flown to surround the other fiber or fibers. The one or more charged or uncharged polymers may function as carriers assisting in electrospinning of the nanofiber mat, or may be function for improving certain properties of the nanofiber mat, or may function as both assisting in electrospinning and improving properties of the nanofiber mat or the electrode made from the nanofiber mat.

In one aspect, the present invention relates to a method of forming electro spun nanofiber mat cathodes. In certain embodiments, the manufacture of the electro spun nanofiber mat cathodes uses commercial platinum/carbon (Pt/C) catalyst with either a neat poly(vinylidene fluoride) (PVDF), or Nafion®/PVDF binder. At first, the nanofiber mats are formed by electro spun the mixture of the catalyst and the binder. Then the nanofiber mats are applied to a membrane, such as a DuPont™ Nafion® PFSA NR-211 (Nafion® 211) membrane, as cathodes (in certain embodiments, as anode). After that, gas diffusion layers are added to form a membrane electrode assembly (MEA), and the MEA can be used as the core component in a H₂/air polymer electrolyte membrane (PEM) fuel cell. In certain embodiments, the anode and cathode Pt loading are about 0.10 mg/cm². In certain embodiments, the Nafion®/PVDF cathode MEA with the smallest amount of PVDF (80/20 Nafion®/PVDF weight ratio) produced the highest maximum power at beginning-of-life (BoL), 545 mW/cm² at 100% RH, which was 35% greater than that for a conventional MEA with a neat Nafion® binder. Carbon corrosion scaled inversely with cathode PVDF content, with a 33/67 Nafion®/PVDF cathode binder MEA producing the highest end-of-life (EoL) power (330 mW/cm²). MEAs with <50 wt. % PVDF in the cathode binder exhibited a power density decline during carbon corrosion, whereas the power increased during/after carbon corrosion for nanofiber cathodes with binders containing >50 wt % PVDF (due to favorable increases in the hydrophilicity of the carbon support and Pt mass activity, couple with a lower carbon loss). Binders with >50 wt. % hydrophobic PVDF, in combination with the cathode nanofiber morphology, helped to minimize undesirable water flooding effects after carbon corrosion.

In certain embodiments, Pt/Co, PtNi, or some other Pt-alloy can be used as catalyst instead of Pt/C.

In another aspect, the present invention relates to a method of forming electro spun nanofiber mat for fuel cell membrane applications. In certain embodiments, the method includes electrospinning a solution of a polymer mixture, an ion conducting ionomer and either a reinforcing polymer or a polymer that can serve a useful function during fuel cell operation, like a hydrophobic polymer that can expel water or a polymer with enhanced oxygen/air permeability, as a single fiber, and then hot pressing into a dense membrane.

In certain embodiments, the ionomer is a perfluorosulfonic acid polymer such as Nafion® and the reinforcing or hydrophobic polymer has a repeat unit of a formula of:

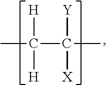

and each of X and Y is a non-hydroxyl group. In certain embodiments, each of X and Y is F, and the reinforcing polymer is poly(vinylidene fluoride) (PVDF) or a copolymer thereof like poly(vinylidene fluoride)-co-hexafluoropropylene.

In a further aspect, the present invention relates to a method of manufacturing a nanofiber duel cell electrode mats. In certain embodiments, the electrodes mats is formed from Nafion® nanofibers and catalyst-bound PVDF nanofibers. The two types of nanofibers are prepared by simultaneously electrospinning fibers from two separate spinnerets. In certain embodiments, the ink for forming the Nafion® nanofibers includes Nafion® and poly(ethylene oxide) (PEO). The Nafion®:PEO ration may be about 100:1. In certain embodiments, the ink for forming the catalyst-bound PVDF nanofibers includes about 75% wt % Pt/C and 25% wt % PVDF.

In yet another aspect, the present invention relates to a fuel cell membrane-electrode-assembly (MEA) manufactured using the cathodes or membranes as described above. In one embodiment, the fuel cell MEA has an anode electrode, a cathode electrode, and a membrane disposed between the anode electrode and the cathode electrode, where at least one of the anode electrode, the cathode electrode and the membrane is formed of nanofibers by electro spinning.

In yet another aspect, the present invention relates to a fuel cell having the above described MEA.

These and other aspects of the present invention are more specifically described below.

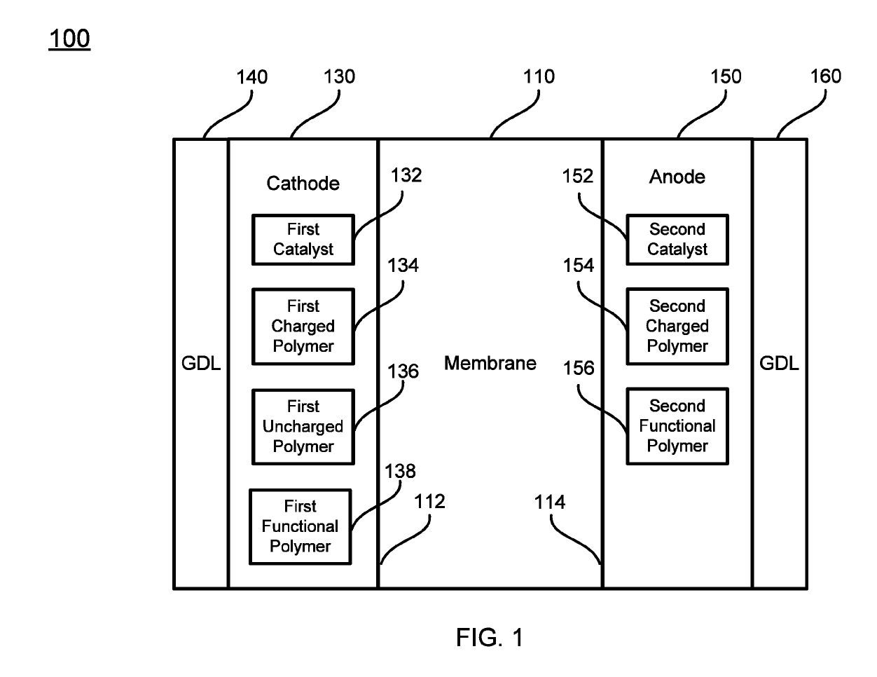

FIG. 1 schematically shows a membrane-electrode-assembly (MEA) for an electrochemical device according to certain embodiments of the present invention. As shown in FIG. 1, the MEA 100 includes a membrane 110, a cathode 130, an anode 150, a first conductive support 140, and a second conductive support 160.

The membrane 110 may be a proton exchange membrane or polymer electrolyte membrane (PEM), which is a semipermeable membrane generally made from ionomers and designed to conduct protons while acting as an electronic insulator and reactant barrier, e.g. to oxygen and hydrogen gas. In certain embodiments, the membrane 110 is a Nafion® 211 membrane or a Nafion® 212 membrane. As shown in FIG. 1, the membrane 110 has a first side 112 and an opposite second side 114. In certain embodiments, the membrane 110 may also be an anion exchange membrane (AEM)

The cathode 130 is attached to the first side 112 of the membrane 110. The cathode 130 is a nanofiber mat having the first catalyst 132, the first charge polymer 134, and the first uncharged polymer 136. The first charged polymer 134 and the first uncharged polymer 136 form a binder for the first catalyst 132. In certain embodiments, the first charged polymer 134 and the first uncharged polymer 136 are in the forms of nanofibers, and the first catalyst 132 are attached to the nanofibers. For example, the majority of the first catalyst 132 may be located at the surface of the nanofibers. In certain embodiments, the first charged polymer 134 is a perfluorosulfonic acid (PFSA), such as Nafion®. In certain embodiments, the first charged polymer 134 may also be a perfluoro imide acid (PFIA) polymer, such as Aquivion®. In certain embodiments, the first uncharged polymer has a repeat unit of

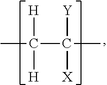

and each of X and Y is a non-hydroxyl group. In certain embodiments, both X and Y is fluoride, and the first uncharged polymer 136 is PVDF. The weight ratio between the first charge polymer 134 and the first uncharged polymer 136 may be about 80:20 to about 20:80. In certain embodiments, the first uncharged polymer 136 may also be a coplolymer of PVDF. In certain embodiments, the first cathode 130 may not include the first charged polymer, and the first uncharged polymer 136 itself acts as the binder. In certain embodiments, the first charged polymer 134 is Nafion and the first uncharged polymer 136 is PAA. In certain embodiments, the cathode 130 may further include a first functional polymer 138 that is different from the first uncharged polymer 136. The first functional polymer 138 may be a charged or an uncharged carrier polymer, to allow for or assist in the effective electrospinning of the polymer/catalyst/solvent mixture. In certain embodiments, the first functional polymer 138 may provide some useful function to the nanofiber cathode 130 during fuel cell operation, such as expel water due to hydrophobicity or enhance oxygen access to the surface via high gas permeability.

The anode 150 is attached to the second side 114 of the membrane 110. The anode 150 may be a nanofiber mat having the second catalyst 152, the second charged polymer 154, and the second uncharged polymer 156. The second charged polymer 154 and the second uncharged polymer 156 form a binder for the second catalyst 152. In certain embodiments, the second uncharged polymer 156 acts as a carrier for the second charged polymer 154. In certain embodiments, the second charged polymer 154 is a perfluorosulfonic acid (PFSA), such as Nafion®. In certain embodiments, The second uncharged polymer has a repeat unit of a formula of:

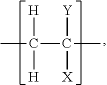

where each of X and Y is a non-hydroxyl group. In certain embodiments, X is hydrogen group, Y is a carboxylic acid group, and the second uncharged polymer is poly(acrylic acid) (PAA). The ratio between the second charge polymer 154 and the second uncharged polymer 156 may be about 100:1. In certain embodiments, each of the first catalyst 132 and the second catalyst 152 is Pt/C or Pt/Co. The first catalyst 132 may be the same as or different from the second catalyst 152. In one embodiment, both the first catalyst 132 and the second catalyst 152 is Pt/C.

In certain embodiments, the structures shown for the cathode 130 and the anode 150 may be the same or different. Each of the cathode 130 and the anode 150 may include at least one charged polymer 134 or 154 and one or more functional polymers. The one or more functional polymers may include charged or uncharged polymers, and each of those one or more functional polymers may function as a carrier for the at least one charged polymer 134 or 154 to assist electrospinning, or function to improve properties of the nanofiber electrode 130 or 150 during fuel cell operation. In certain embodiments, when the one or more functional polymers is PVDF, the PVDF may function as both a carrier and function to improve the hydrophobicity of the electrode.

The first conductive support 140 is attached to the outside of the cathode 130, and the second conductive support 160 is attached to the outside of the anode 150. In certain embodiments, both the first conductive support 140 and the second conductive support 160 are gas diffusion layers (GDL).

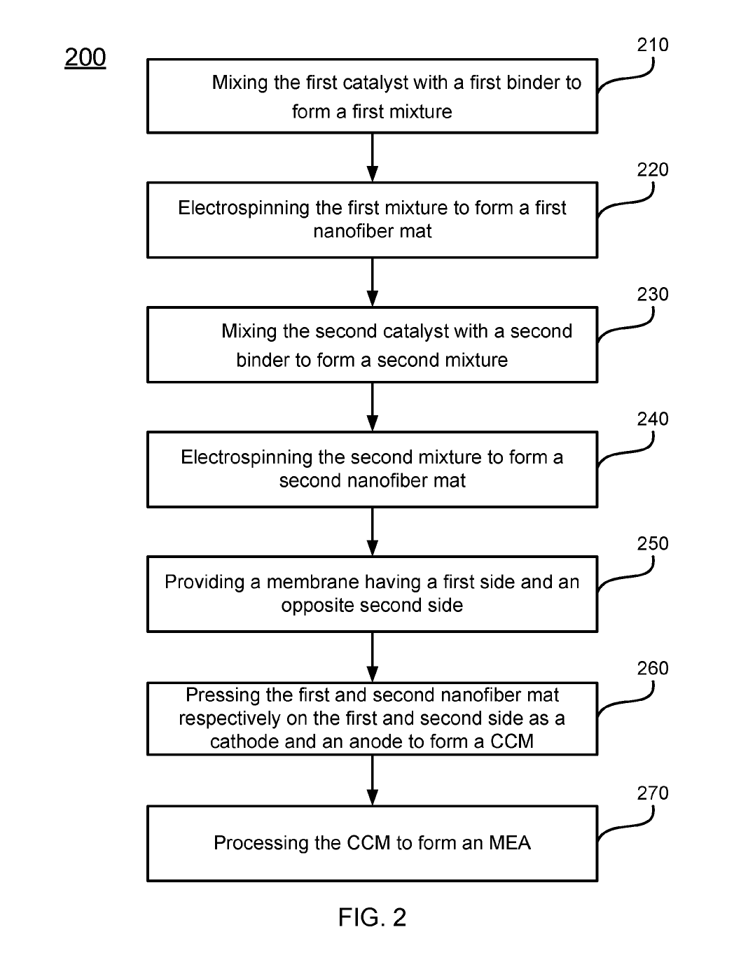

FIG. 2 shows a flowchart of forming an MEA according to one embodiment of the present invention. As shown in FIG. 2, a method of forming an MEA 200 includes procedures 210 to 270. It should be particularly noted that, unless otherwise stated in the present invention, the steps of the method may be arranged in a different sequential order, and are thus not limited to the sequential order as shown in FIG. 2. In certain embodiments, the method as shown in FIG. 2 may be implemented to manufacture the MEA as shown in FIG. 1.

At procedure 210, a first catalyst is mixed with a first binder to form a first mixture. In certain embodiments, the first catalyst is Pt/C catalyst. In certain embodiments, the first binder includes Nafion® and PVDF, and a weight ratio between the Nafion® and PVDF is about 80:20 to about 20:80. In certain embodiments, the first binder may be neat PVDF. In certain embodiments, the ratio between the first catalyst and the first binder may be about 70:30. In addition to the first catalyst and the first binder, the first mixture may also include other solvents. The first mixture may also be termed as an ink.

At procedure 220, the first mixture is electrospun to form a first nanofiber mat. In certain embodiments, the electrospun is performed at room temperature in a custom-built environment chamber with relative humidity control. In certain embodiments, the first mixture is drawn into a 3 mL syringe and electrospun using a single 22-gauge stainless steel single orifice needle spinneret, where the needle tip was polarized to a high positive potential relative to a grounded stainless steel rotating drum collector. The spinneret-to-collector distance is fixed at 10 cm and the flow rate of the first mixture or the ink is at 1.0 mL/h. Nanofibers are collected on aluminum foil that is attached to the collector drum. The drum rotates at a speed of 100 rpm and oscillates horizontally to improve the uniformity of a deposited nanofiber mat. The voltage is in the 12-15 kV range, and the relative humidity is controlled at about 50-70% RH.

At procedure 230, the second catalyst is mixed with a second binder to form a second mixture. In certain embodiments, the second catalyst is Pt/C catalyst. In certain embodiments, the second binder includes Nafion® and PAA, and a weight ratio between the Nafion® and PAA is about 2:1. In certain embodiments, the ratio between the second catalyst and the second binder or carrier may be about 70:30. In addition to the second catalyst and the second binder, the second mixture may also include other solvents. The second mixture may also be termed as an ink.

At procedure 240, the second mixture is electrospun to form a second nanofiber mat. In certain embodiments, the electrospun is performed the same as or different from the procedure 220.

At procedure 250, a membrane is provided, which has a first side and an opposite second side. The membrane may be a PEM. In certain embodiments, the membrane is a Nafion® 211 membrane.

At procedure 260, the first nanofiber mat is hot pressed on the first side of the membrane as a cathode, and the second nanofiber mat is hot pressed on the second side of the membrane as an anode, so as to form a catalyst coated membrane (CCM). In certain embodiments, the procedure 260 is performed by hot pressing 5 cm² electrospun particle/polymer nanofiber mats produced at procedure 220 and 240 onto the opposing surfaces of a Nafion® 211 membrane at 140° C. and 4 MPa for 2 minutes, after a 10-minute pre-heating period at 140° C. with no applied pressure. In certain embodiments, the procedure 260 may include heating, compaction, solvent vapor exposure, and/or thermal annealing.

At procedure 270, the CCM is processed to form an MEA. The procedure 270 may be performed by physically pressing carbon paper gas diffusion layers (GDLs) (Sigracet 25 BC GDL) respectively onto outside surfaces of the cathode and the anode of the CCM. In certain embodiments, the formed MEA may be used to manufacture a fuel cell. In certain embodiments, the step of processing the CCM to form the MEA includes acid treating CCM before pressing the carbon gas diffusion layer onto the CCM.

In certain embodiments, electrospun fiber electrode mats are formed from two or more different fibers by co-electro spun. Each fiber is composed of a different binder and/or different catalyst and/or where some fibers have no catalyst at all, but contain polymer/particles that help with electrode operation (like fibers with a hydrophilic polymer with silica particles for better electrode water retention).

In certain embodiments, electrospun fibers contain both catalyst particles and non-catalytic particles (e.g., silica particles for water retention) with an ionomer binder.

Without intent to limit the scope of the invention, examples and their related results according to the embodiments of the present invention are given below. Note that titles or subtitles may be used in the examples for convenience of a reader, which in no way should limit the scope of the invention. Moreover, certain theories are proposed and disclosed herein; however, in no way they, whether they are right or wrong, should limit the scope of the invention so long as the invention is practiced according to the invention without regard for any particular theory or scheme of action.

### Example 1

### Nanofiber Fuel Cell Cathodes with PVDF and Nafion®/PVDF Binders

In this example, electrospun nanofiber mat cathodes with commercial platinum/carbon (Pt/C) catalyst and either a neat poly(vinylidene fluoride) (PVDF), or Nafion®/PVDF blended polymer binder were used in a H₂/air polymer electrolyte membrane (PEM) fuel cell. Membrane-electrode-assemblies (MEAs) were prepared with an electrospun anode and a DuPont™ Nafion® PFSA NR-211 (Nafion® 211) membrane, where the anode and cathode Pt loading was 0.10 mg/cm². The effect of cathode binder composition (PVDF and Nafion®/PVDF blends with weight ratios ranging from 80/20 to 20/80) on fuel cell power output at 100% and 40% relative humidity (RH) was investigated. Polarization curves were recorded at 80° C. and ambient pressure before, intermittently, and after a carbon corrosion voltage cycling experiments. The Nafion®/PVDF cathode MEA with the smallest amount of PVDF (80/20 Nafion®/PVDF weight ratio) produced the highest maximum power at beginning-of-life (BoL), 545 mW/cm² at 100% RH, which was 35% greater than that for a conventional MEA with a neat Nafion® binder. Carbon corrosion scaled inversely with cathode PVDF content, with a 33/67 Nafion®/PVDF cathode binder MEA producing the highest end-of-life (EoL) power (330 mW/cm²). MEAs with <50 wt. % PVDF in the cathode binder exhibited a power density decline during carbon corrosion, whereas the power increased during/after carbon corrosion for nanofiber cathodes with binders containing >50 wt % PVDF (due to favorable increases in the hydrophilicity of the carbon support and Pt mass activity, couple with a lower carbon loss). Binders with >50 wt. % hydrophobic PVDF, in combination with the cathode nanofiber morphology, helped to minimize undesirable water flooding effects after carbon corrosion.

In a series of recent papers, Pintauro and coworkers have shown that an electrospun nanofiber cathode, composed of Pt/C particles and a binder of Nafion®+poly(acrylic acid) (PAA) performs remarkably well in a hydrogen/air proton exchange membrane fuel cell [3-5]. For example, a nanofiber electrode MEA with a 0.055 mg_{Pt}/cm² cathode and 0.059 mg_{Pt}/cm² anode (Johnson Matthey Pt/C catalyst) produced more than 900 mW/cm² at maximum power in a H₂/air fuel cell at 80° C., 100% RH, and high feed gas flow rates at 2 atm backpressure [4]. In a recent collaborative study between Vanderbilt University and Nissan Technical Center North America, Brodt et al. [5] showed that MEAs with an electrospun particle/polymer cathode generated high beginning-of-life power and also exhibited excellent durability, as determined from end-of-life polarization curves after an accelerated start-stop voltage cycling (carbon corrosion) test. Thus, after 1,000 simulated start-stop cycles, a nanofiber MEA with Johnson Matthey Pt/C catalyst and a binder of Nafion®+PAA maintained 53% of its initial power at 0.65 V and 85% of its maximum power, as compared to a 28% power retention at 0.65 V and 58% retention at maximum power for a sprayed electrode MEA. The excellent initial performance of nanofiber fuel cell electrodes was attributed to the unique nanofiber electrode morphology, with inter-fiber and intra-fiber porosity which results in better accessibility of oxygen to Pt catalyst sites and the efficient removal of product water. The superior end-of-life performance of the nanofiber MEA after a carbon corrosion test was attributed to the combined effects of a high initial electrochemical cathode surface area, the preservation of the nanofiber structure after testing, and the rapid/effective expulsion of product water from the cathode which minimizes/eliminates flooding.

Cathode carbon corrosion is a serious durability issue that occurs in a hydrogen/air fuel cell stack when a hydrogen-air mixture is present in the anode during start-up. The resulting spike in the cathode voltage to a potential of about 1.5 V vs. SHE produces severe corrosion of the carbon support material of the cathode catalyst, with associated damage by electrode layer thinning and disintegration, platinum nanoparticle agglomeration, and the loss of catalytically active platinum surface area [6, 7]. Surface oxides may also form, making the cathode layer more hydrophilic and prone to water flooding, which drastically reduces oxygen access to active catalytic sites [8]. System control strategies have been sought to minimize these voltage spikes, but no practical solutions have emerged to eliminate the problem [9]. At the materials level, researchers have been investigating new catalyst supports that are not susceptible to corrosion, including metal oxides and thermally treated carbon supported catalysts [10-13]. Another approach is the complete removal of all Pt support material from the cathode layer, as is the case with 3M Company's nanostructure thin film structured Pt whisker electrodes [14].

The hydrophobicity of the catalyst carbon surface is a critical factor in determining its corrosion resistance in an MEA fuel cell, since water is directly involved in the electrochemical oxidation of the carbon support material in a fuel cell cathode [14, 18] (via Equation 1). In certain embodiments of the present invention, the introduction of a hydrophobic polymer, such as poly(vinylidene fluoride) (PVDF) into the cathode catalyst binder will slow carbon corrosion rates.

C+2H₂O→CO₂+4H⁺+4e⁻ (Eq. 1)

The use of a PVDF electrode binder, however, is challenging because it does not conduct protons and its oxygen permeability is low. Nevertheless, it has been used with some success as the electrode binder in PBI-based hydrogen/air fuel cell electrodes [15].

In this example, new results are presented on the initial power and carbon corrosion durability of nanofiber MEAs with a cathode binder of neat PVDF or various Nafion®/PVDF blends, where the binder composition alters/minimizes the concentration of water at the surface of Pt/C particles. Methods for electrospinning high Pt/C content nanofibers with these new binders were identified and MEAs were fabricated with the resulting nanofiber mat cathodes. Fuel cell tests were carried out to compare beginning-of-life (BoL) and end-of-life (EoL) fuel cell power output after a carbon corrosion voltage cycling experiment for nanofiber and conventional painted GDE cathode MEAs of the same binder composition and Pt loading.

It is generally known that Nafion® and PVDF are incompatible/immiscible polymers which phase-separate when solution cast into thin film membranes [16]. In certain embodiments of the present invention, we have found that well-mixed PVDF/Nafion® blends with nm-domains can be prepared by electrospinning Nafion®+PVDF mixtures [17]. In this example, the chemistry/morphology of Nafion®/PVDF blended fibers was not discussed in detail, while the use of these blends as binders in hydrogen/air fuel cell cathodes was emphasized.

Materials—

Johnson Matthey HiSpec®4000 (40% Pt on Vulcan carbon) catalyst was used for all electrodes. 450 kDa molecular weight poly(acrylic acid) (PAA) was purchased from Sigma Aldrich, from which a 15 wt % stock solution was created in 2:1 (w:w) isopropanol (IPA):water solvent. Kynar® HSV 900 polyvinylidene fluoride (Arkema, Inc.) was used to prepare a 10 wt % stock solution in 7:3 (w:w) dimethylformamide (DMF):acetone. 1100 EW Nafion® ion resin (purchased from Ion Power®) was dried to solid crystals and used to make two different stock solutions: (1) a 20 wt % Nafion® solution in 2:1 (w:w) n-propanol:water, for inks containing PAA and (2) a 20 wt % Nafion® solution in 7:3 (w:w) DMF:acetone for inks made with PVDF.

Electrospinning Electrodes—

Table 1 lists the compositions for each cathode electrospinning ink and final dry nanofiber cathode. Inks were prepared using the following sequence: (i) wetting catalyst with water (ink 1 in Table 1) or DMF (inks 2-7), (ii) adding the appropriate amount of isopropanol (IPA) (ink 1), tetrahydrofuran (THF) (inks 2-6), or acetone (ink 7), (iii) adding the appropriate weight of Nafion® via stock solutions A or B (defined in Table 1), (iv) sonicating the suspension for 90 minutes with intermittent mechanical stirring, (v) adding PAA (stock solution C for ink 1) or PVDF (stock solution D for inks 2-7), and (vi) stirring the ink mechanically for 12 hours. The final inks contained catalyst powder with (i) Nafion® and PAA in alcohol/water solvent, (ii) PVDF in DMF/acetone, or (iii) Nafion®+PVDF in a solvent of DMF/THF/acetone. Nafion® lacks the necessary chain entanglements and will not electrospin into well-formed fibers unless a suitable carrier polymer is added to the electrospinning solution [19]. In the present study, PAA or PVDF acted as the carrier.

TABLE 1
Electrospinning Ink Composition and Final Dry
Nanofiber Composition of Electrospun Cathodes

| | | Dry Electrode |
|---|---|---|
| | | Composition |
| Ink | Ink Composition (g) | (Wt %) |
| 1 | 0.20 g catalyst, 0.80 g water, 0.53 g IPA, 0.37 g | 64 catalyst, |
| | stock solution A¹, 0.25 g stock solution C³ | 24 Nafion, |
| | | 12 PAA |
| 2 | 0.20 g catalyst, 0.27 g DMF, 0.80 g THF, 0.34 g | 70 catalyst, |
| | stock solution B², 0.173 g stock solution D⁴ | 24 Nafion, |
| | | 6 PVDF |
| 3 | 0.20 g catalyst, 0.67 g DMF, 0.60 g THF, 0.29 g | 70 catalyst, |
| | stock solution B, 0.29 g stock solution D | 20 Nafion, |
| | | 10 PVDF |
| 4 | 0.20 g catalyst, 0.52 g DMF, 0.52 g THF, 0.214 g | 70 catalyst, |
| | stock Solution B, 0.43 g stock solution D | 15 Nafion, |
| | | 15 PVDF |
| 5 | 0.20 g catalyst, 0.78 g DMF, 0.68 g THF, 0.145 g | 70 catalyst, |
| | stock solution B, 0.57 g stock solution D | 10 Nafion, |
| | | 20 PVDF |
| 6 | 0.20 g catalyst, 0.85 g DMF, 0.75 g THF, 0.09 g | 70 catalyst, |
| | stock solution B, 0.70 g stock solution D | 6 Nafion, |
| | | 24 PVDF |
| 7 | 0.20 g catalyst, 0.30 g DMF, 1.6 g acetone, 0.87 g | 70 catalyst, |
| | stock solution D | 30 PVDF |

¹Stock Solution A: 20 wt % Nafion in 2:1 n-propanol:water w:w
²Stock Solution B: 20 wt % Nafion, in 7:3 DMF:acetone w:w
³Stock Solution C: 15 wt % PAA in 2:1 IPA:water w:w
⁴Stock Solution D: 10 wt % PVDF in 7:3 DMF:acetone w:w

Electrospinning was performed at room temperature in a custom-built environmental chamber with relative humidity control [18]. An ink was drawn into a 3 mL syringe and electrospun using a single 22-gauge stainless steel single orifice needle spinneret, where the needle tip was polarized to a high positive potential relative to a grounded stainless steel rotating drum collector. The spinneret-to-collector distance was fixed at 10 cm and the flow rate of ink was held constant for all experiments at 1.0 mL/h. Nanofibers were collected on aluminum foil that was attached to the collector drum. The drum rotated at a speed of 100 rpm and oscillated horizontally to improve the uniformity of a deposited nanofiber mat. The voltage was in the 12-15 kV range for all ink recipes. Ink 1 (Table 1) was electrospun at 40% RH and inks 2-7 were electrospun at 50-70% RH.

SEM Imaging of Nanofiber Mats:

Top-down SEM images of electrospun nanofiber mats were taken with a Hitachi 54200 Scanning Electron Microscope with a 5.0 kV electron beam. Prior to imaging, the mats were lightly pressed at room temperature onto conductive SEM tape and then sputter coated with a thin layer of gold to improve contrast.

Membrane-Electrode-Assembly (MEA) Preparation:

CCMs (Catalyst Coated Membranes) with nanofiber electrodes were fabricated by hot pressing 5 cm² electrospun particle/polymer nanofiber mats onto the opposing surfaces of a Nafion® 211 membrane at 140° C. and 4 MPa for 2 minutes, after a 10-minute pre-heating period at 140° C. with no applied pressure. The Pt loading of a nanofiber mat was calculated from the total electrode weight and the weight-fraction of Pt/C catalyst used in the electro spinning ink. Carbon paper gas diffusion layers (GDLs) (Sigracet 25 BC GDL) were physically pressed onto a CCM's anode and cathode while in the fuel cell test fixture to form an MEA.

Painted gas diffusion electrodes (GDEs) were also fabricated. Catalyst/PVDF or catalyst/Nafion®/PVDF inks were painted in multiple layers directly onto a carbon paper gas diffusion layer (Sigracet GDL 25 BC) and dried at 70° C. for 30 minutes after depositing each layer. The same Nafion®/PVDF ink recipes (inks 2-7 in Table 1) were used for the painted GDEs, except an additional 1.0 g of DMF and 1.0 g of acetone was added to each ink, in order to decrease the ink viscosity so that thin layers could be easily spread onto the carbon paper. Conventional cathode GDEs were also prepared with a composition of 70 wt % catalyst and 30% Nafion®, using n-propanol/water as the solvent. All painted GDEs (5 cm² in geometric area) were hot pressed onto Nafion® 211 membranes at 140° C. and 4 MPa for 2 minutes after a 10 minute pre-heating step at 140° C. with no applied pressure (same conditions as the nanofiber electrodes).

The Pt loading of both nanofiber and GDE cathodes was fixed at 0.10 mg/cm². All nanofiber and GDE cathode MEAs contained a nanofiber anode with Nafion®/PAA binder (electro spinning ink 1 from Table 1) at a Pt loading of 0.10 mg/cm².

Fuel Cell Tests:

Fuel cell tests were performed on 5 cm² MEAs, using a Scribner Series 850e test station with mass flow, temperature, and manual backpressure control. The fuel cell test fixture accommodated a single MEA and contained single anode and cathode serpentine flow channels. Experiments with fully humidified H₂ and air at atmospheric (ambient) pressure were performed at 80° C. where the H₂ flow rate was 125 sccm and the airflow rate was 500 sccm. Prior to collecting polarization data, MEAs were pre-conditioned at 80° C. with fully humidified air and hydrogen by alternating every 2 minutes between operation at 150 mA/cm² and 0.2 V. This break-in process was continued until steady-state was achieved (typically about 4 hours, but as long as 12 hours for cathodes with a neat PVDF binder). Polarization curves were generated by measuring the voltage at a given current in the anodic (positive voltage) direction after waiting two minutes for system stabilization. High frequency resistance (HFR) data were collected at 6000 Hz.

Electrochemical Surface Area (ECA) and Mass Activity:

In-situ cyclic voltammetry (CV) measurements were performed on 5 cm² MEAs, with a sweep rate of 20 mV/s, where a H₂-purged anode served as both counter and reference electrodes and N₂ was fed to the working cathode. The fuel cell test fixture was operated at 30° C. with gas feed streams at a dew point of 30° C. (fully humidified). A cyclic voltammogram was generated between +0.04 V and +0.9 V vs. SHE and the electrochemically active surface area was determined from the integrated area above the hydrogen adsorption portion of the curve (corresponding to a voltage range of approximately +0.1 to +0.4 V), where the charge required to reduce one monolayer of hydrogen atoms on Pt was assumed to be 210 μC/cm². Pt cathode mass activity measurement data was collected with a current-controlled anodic scan (high current to low current) at 80° C. with fully humidified O₂ and H₂ gas feeds at 100 sccm and 1.5 atm (150 kPa_{abs}). The system was given 3 minutes to stabilize at each current density before a voltage reading was taken. Mass activities were determined at 0.90 V from a plot of IR-free voltage verse the H₂-crossover corrected current density. BoL and EoL mass activities were based on an initial Pt loading of 0.10 mg_{Pt}/cm².

Cathode Durability Tests:

MEAs were tested under the Fuel Cell Commercialization Conference of Japan's (FCCJ) standard start-stop potential cycling protocol [20]. For a carbon corrosion accelerated durability test, the voltage at the cathode was cycled between 1.0 and 1.5 V at a scan rate 500 mV/s with a triangular wave. 1,000 total voltage cycles were performed on a single MEA, where the fuel cell was supplied with 125 sccm H₂ at the anode and 250 sccm N₂ at the cathode (both feed gases were fully humidified at ambient pressure). Beginning-of-life (BoL) and end-of-life (EoL) polarization curves were collected as well as intermittent polarization curves at cycle number 100, 250, and 500. This accelerated durability test simulates start-up and shut-down of a stack without the application of any operational controls that may mitigate fuel cell performance losses. CO₂ was monitored in the cathode exhaust using a non-dispersive infrared CO₂ detector from CO₂ Meter Inc. (Model No. CM-0152), provided an additional experimental tool for measuring carbon corrosion during the accelerated potential cycling tests. Nafion® tubing and a water-trap upstream to the detector inlet removed moisture from the CO₂-containing stream. The highly selective and semi-permeable Nafion® tubing allowed water vapor transfer from the cathode exhaust stream to the drier ambient air, but it did not allow transfer of CO₂.

Analysis of Nanofiber Cathodes with Nafion®/PAA, Nafion® PVDF or Neat PVDF Binder:

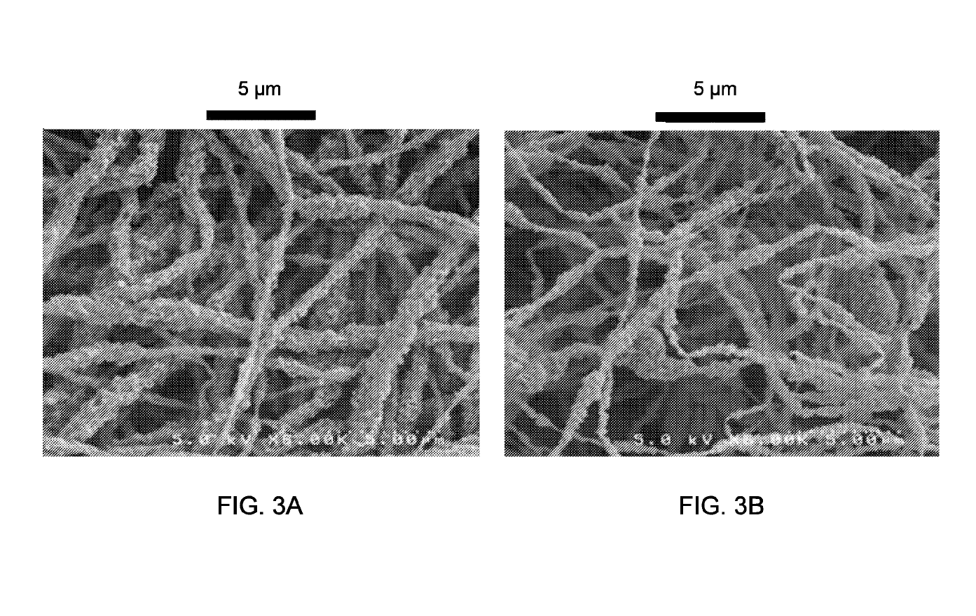

In certain embodiments of the present invention, it has already been shown that MEAs with nanofiber mat cathodes composed of Pt/C powder and a catalyst binder of Nafion®+poly(acrylic acid) (abbreviated as PAA) produce higher power at beginning-of-life (BoL) and have better durability after an accelerated carbon corrosion test, as compared to MEAs with a conventional GDE slurry or sprayed cathode [5]. In this example, polyvinylidene fluoride (PVDF) was investigated as: (1) a carrier polymer for Nafion® fiber electrospinning (an alternative to PAA) and (2) the sole binder or a blending agent with Nafion® to increase the hydrophobicity and carbon corrosion resistance of the cathode. Initial MEA fuel cell tests were performed with two limiting case PVDF-containing binders: (1) neat PVDF and (2) 80/20 wt % Nafion®/PVDF, which represents the minimum PVDF content required to electrospin well-formed electrode fibers with Nafion® and Pt/C powder. The final (dry) cathode fiber composition for these two cases is 70 wt % Pt/C+30 wt % PVDF for the neat PVDF mat case and 70 wt % Pt/C+24 wt % Nafion®+6 wt % PVDF for the 80/20 Nafion®/PVDF mat. As shown by the SEM images in FIG. 3A and FIG. 3B, electrospun Pt/C catalyst fibers with PVDF and Nafion®/PVDF binders appear to be highly porous with a roughened surface. The overall fiber/mat morphology is nearly identical to catalyst fibers electrospun with Nafion®/PAA binder [4, 5], although there was some variability in fiber diameter and catalyst content along the length of 80/20 Nafion®/PVDF fibers. The mat with a neat PVDF binder had an average fiber diameter of 620 nm and the average fiber diameter for the 80/20 Nafion®/PVDF mat was 450 nm. The observed fiber structure is a direct consequence of the electrospinning process, where catalyst and binder are well mixed due to high sheer stresses within the catalyst ink at the spinneret tip followed by fiber elongation as the filament travels to the collector surface and rapid solvent evaporation which “freezes in” a well-dispersed particle/polymer morphology with significant intra-fiber voids and a very thin coating of binder on all catalyst particles.

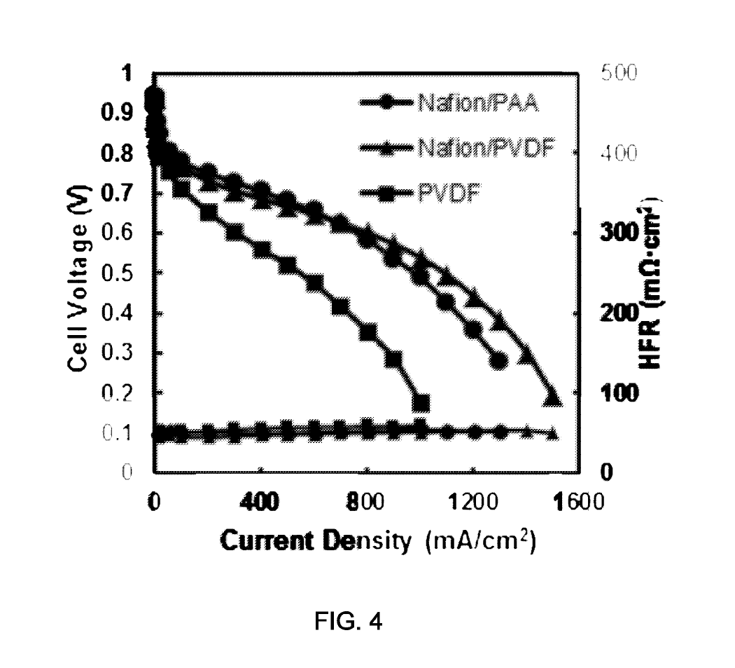

In FIG. 4, beginning-of-life (BoL) hydrogen/air fuel cell polarization curves are shown for MEAs with cathodes containing 80/20 Nafion®/PVDF and neat PVDF binders at a cathode Pt loading of 0.10 mg/cm². For comparison, V-i data are also presented for a 0.10 mg/cm² nanofiber cathode with a binder of Nafion®/PAA (ink 1 in Table 1) where the fiber composition is 64 wt % Pt/C+24 wt % Nafion®+12 wt % PAA (similar to that in Reference 5). Data were collected at 80° C. with air and hydrogen at ambient pressure and 100% relative humidity (RH). The HFR for all three MEAs was essentially the same, indicating good electrode/membrane adhesion and minimal contact resistance [25] and all MEAs utilized the same kind of nanofiber anode (binder and Pt loading), so any changes in MEA power output were attributed to the functioning of the cathode. The Nafion®/PVDF and Nafion®/PAA cathode MEAs generated similar polarization curves, with the Nafion®/PVDF cathode MEA having slightly higher current densities at voltages <0.65 V (associated with better water expulsion at high current densities) and slightly smaller current densities at voltages >0.65 V (insufficient water at the catalyst surface sites for fast ORR [21]). With regards to the former observation, an improvement in cathode mass transfer due to an increase in binder hydrophobicity has been reported previously by Song et al [24] who found that an MEA with a cathode binder composed of 5 wt % polytetrafluoroethylene (PTFE) and 95% Nafion® had lower ORR catalytic activity, but produced more power at low voltages (e.g. about 20% more power at 0.4 V, as compared to a standard Nafion® binder MEA). Consequently, the maximum power density for the Nafion®/PVDF cathode MEA was 13% higher than that for a nanofiber cathode MEA with a Nafion®/PAA binder cathode (545 vs. 484 mW/cm²). The neat PVDF cathode MEA, with no proton conducting ionomer in the cathode binder, worked surprisingly well (current densities >1 A/cm² were achieved), but not at the same performance level as MEAs with Nafion® as a binder component. Low power was associated with the low water content of the PVDF binder, which restricted proton migration and adversely affected ORR kinetics and the low oxygen permeability of PVDF (at 0.09 barrers [22], the oxygen permeability of PVDF is about two orders of magnitude lower than that in wet Nafion® [23]). Current flow and some level of proton transport in ionomer-free fuel cell cathodes has been observed previously and associated with the presence of oxide species and water at the Pt/C catalyst surface, but the general phenomenon is not well understood [26, 27] and it is not known if such surface oxide species were affecting PVDF cathode performance in the present study.

The Effect of Nafion®/PVDF Weight Ratio on Nanofiber Cathode Performance: The effect of cathode binder composition on initial fuel cell performance and cathode durability after an accelerated carbon corrosion test was assessed for a range of Nafion®/PVDF weight ratios (80/20, 67/33, 50/50, 33/67, 20/80, and 0/100). Power generation was compared to a MEA with a conventional (painted) GDE cathode with a neat Nafion® binder. For all cathodes, the Pt loading was fixed at 0.10 mg/cm² and the total binder content was constant relative to the amount of catalyst at 30 wt %.

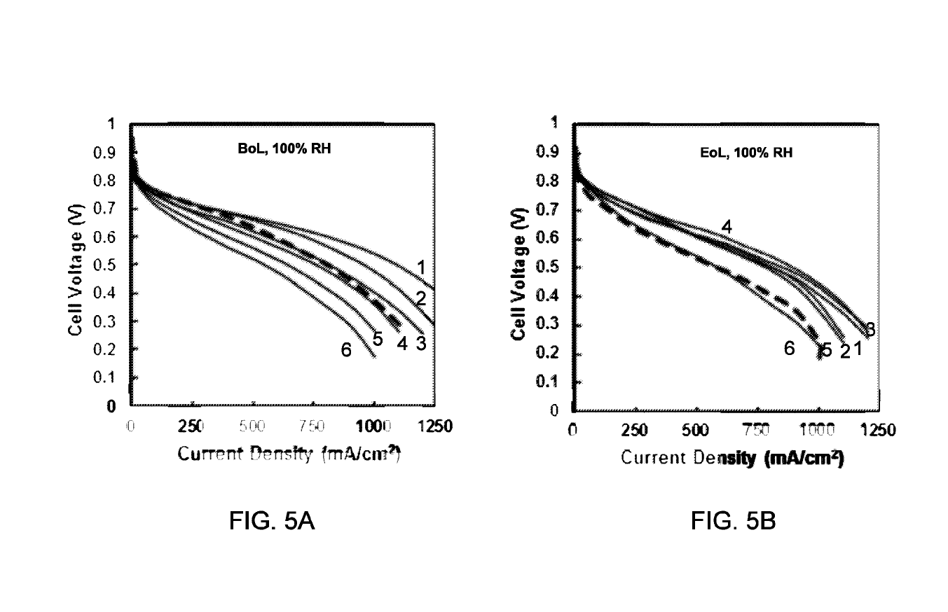

The beginning-of-life (BoL) polarization curves in FIG. 5A contrast the differences between MEAs with Nafion®/PVDF nanofiber and neat Nafion® GDE cathodes. As the PVDF content of the nanofiber cathode binder was increased from 20 to 100 wt. %, less power was generated for all voltages. Nafion®/PVDF nanofiber cathode MEAs with a PVDF content ≤50 wt. % performed well at high and low current densities, due to the combined effects of: (i) the nanofiber mat architecture, with inter-fiber and intra-fiber porosity, (ii) adequate binder hydrophilicity for fast ORR currents in the high voltage region of a polarization curve, and (iii) a sufficient amount of hydrophobic PVDF for facile water expulsion from the fibers at high current densities. The poor BoL power generation of nanofiber cathode MEAs where the binder was predominantly PVDF was not entirely surprising, given the poor results for the neat PVDF nanofiber MEA in FIG. 4.

At EoL, after the voltage cycling carbon corrosion tests, there was a much smaller difference in power output among the Nafion®/PVDF nanofiber cathode MEAs (see FIG. 5B). Nafion®/PVDF nanofiber MEAs with >50 wt % Nafion® exhibited a decrease in power density at EoL, which was not unexpected. Surprisingly, there was an increase in power at EoL for those nanofiber MEAs with a PVDF binder content greater than 50 wt %. After 1,000 voltage cycles, all Nafion®/PVDF nanofiber cathode MEAs generated more power than the conventional neat Nafion® GDE MEA. At EoL, the polarization curve for the conventional MEA was essentially identical to that for the neat PVDF nanofiber cathode MEA, another surprising and unanticipated result.

Comparison of Nanofiber and Painted GDE MEAs with Nafion/PVDF Cathode Binders:

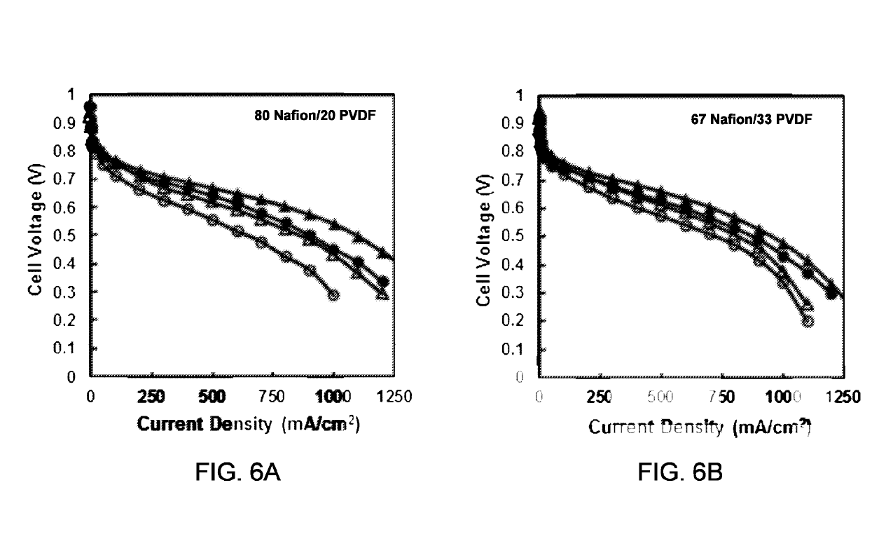

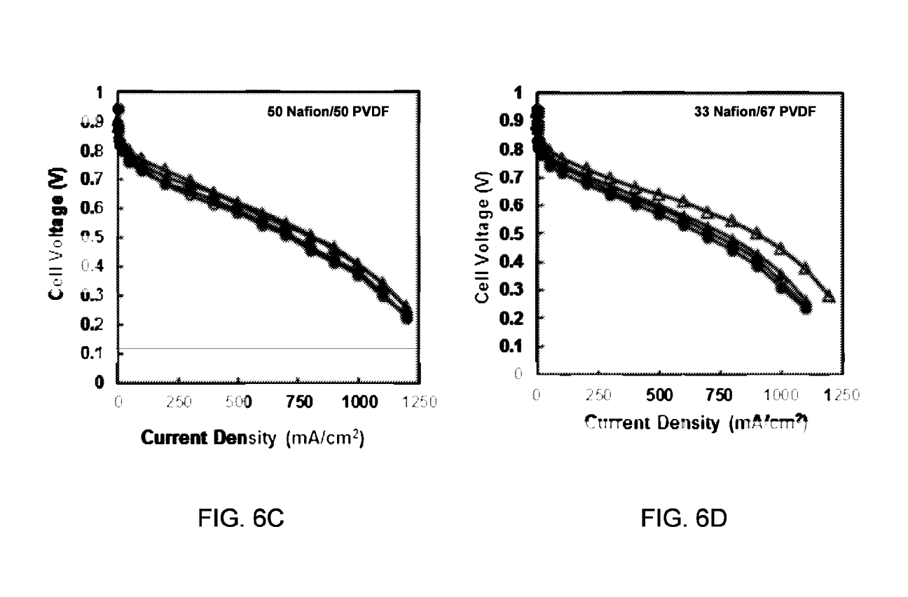

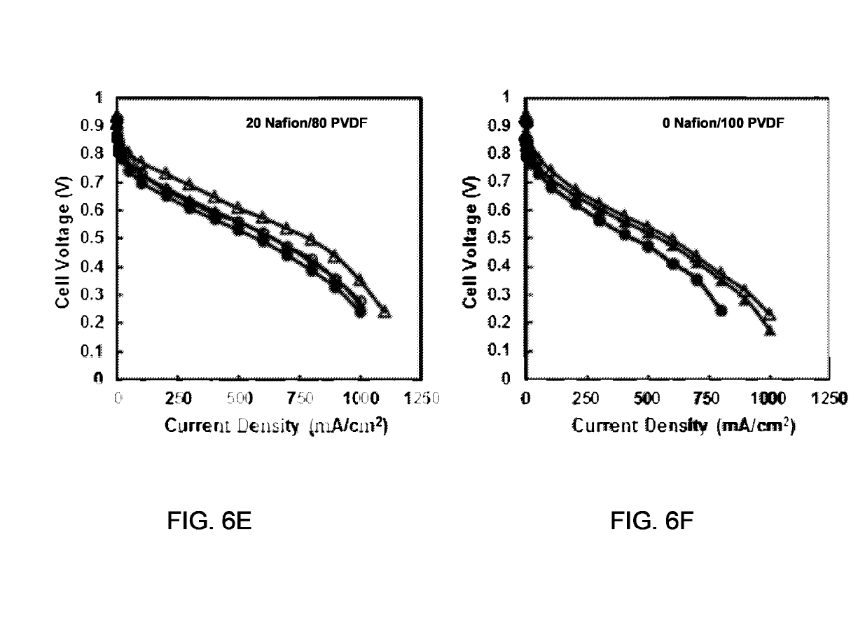

In an effort to decouple the effects of nanofiber morphology and Nafion/PVDF binder compositions on MEA performance, painted GDEs were created and tested with the same cathode binders as the nanofibers in FIG. 5A and FIG. 5B. Fuel cell BoL and EoL results are shown in FIGS. 6A-6F. The measured HFR (not shown in FIGS. 6A-6F) was constant at 50±5 mΩ·cm² for nanofiber and painted/conventional cathode MEAs for all cathode binder compositions at both BoL and EoL. Overall, the Nafion®/PVDF and neat PVDF nanofiber MEAs produced higher power than their painted GDE MEA analogues at both BoL and EoL. The improvement in MEA performance at BoL was associated with the nanofiber mat morphology, with inter and intra fiber porosity and a thin and uniform coating of binder on all catalyst particles which enhances oxygen access to Pt surface sites and facilitates water removal. At EoL, the Nafion®/PVDF nanofiber and GDE cathode MEAs showed three similar trends: (1) Nafion®/PVDF binder MEAs with >50 wt % Nafion® lost power after the corrosion test, (2) MEAs with >50 wt % PVDF generated more power after carbon corrosion, i.e., the EoL/BoL power density ratio was >1.0, and (3) the power densities at BoL and EoL were essentially the same with a 50/50 Nafion®/PVDF binder. Thus, the relative changes in EoL vs. BoL power appear to be controlled by cathode binder composition and not by cathode morphology. At the same time, there were differences in MEA behavior due to cathode structure. EoL power losses for nanofiber cathode MEAs with low PVDF content were always smaller than those for GDE cathode at the same Nafion®/PVDF binder composition, e.g., for 80/20 Nafion®/PVDF cathode binder, the painted cathode MEA lost 48% of its initial power at 0.65 V and 26% of its maximum power, as compared to a 38% power loss at 0.65 V and 20% power loss at maximum power for the nanofiber cathode MEA. Similarly, power increases after carbon corrosion (EoL relative to BoL) were always greater for nanofiber cathodes, where, for example, the largest relative improvement in fuel cell performance was seen with a 20/80 Nafion®/PVDF MEA, i.e., the blended polymer binder with the least amount of Nafion®, where the EoL power increased by 36% at 0.65 V for a nanofiber cathode but only a 20% increase for the painted GDE cathode.

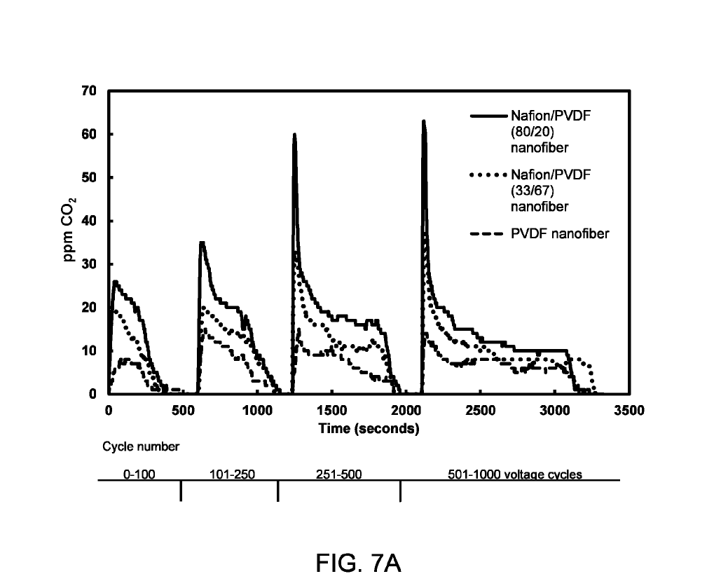

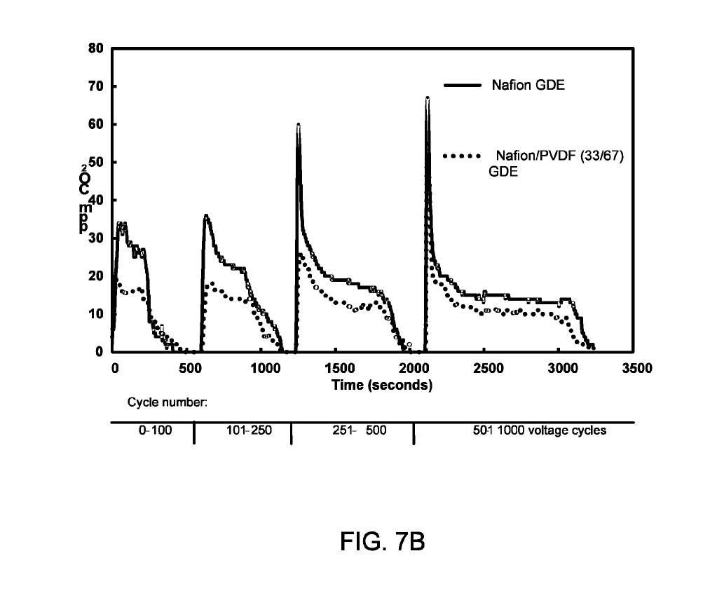

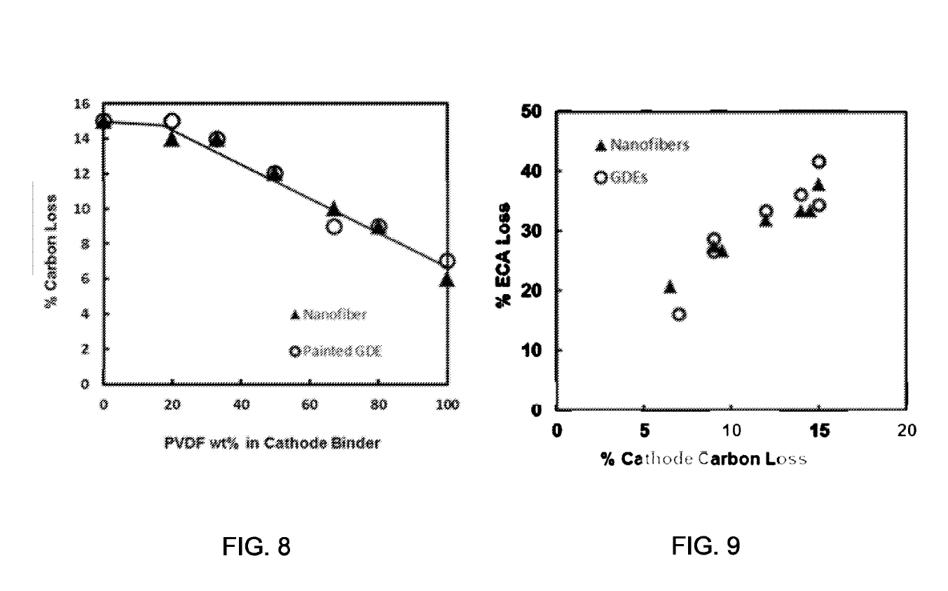

Similarities and differences between nanofiber and GDE cathodes are further revealed by the measured cathode carbon loss during a voltage cycling experiment and by the measured electrochemically active cathode area and cathode kinetic parameters at BoL and EoL. FIG. 7A and FIG. 7B show typical CO₂ concentration vs. time plots during a voltage cycling accelerated carbon corrosion experiment. The shape of these curves is similar to that reported previously, where the spikes in CO₂ are attributed to the rapid decomposition of accumulated surface oxide species on the Pt carbon support material [35, 36]. The cumulative carbon loss for all nanofiber and GDE cathodes after 1,000 voltage cycles is presented in FIG. 8 for Nafion®/PVDF binders of different PVDF content. The extent of carbon support corrosion was strongly dependent on the amount of PVDF in the cathode binder, but not on cathode morphology (nanofiber vs. painted). The decrease in carbon corrosion with increasing PVDF content is attributed to the binder hydrophobicity, with less water at the Pt/C cathode surface [37, 38].

Measured nanofiber and GDE cathode electrochemical surface areas (ECAs) and kinetic parameters for ORR (mass activity and Tafel slope) at BoL and EoL are listed in Table 2 for the different cathode binders. The BoL ECAs for nanofiber and GDE MEAs are essentially independent of the Nafion®/PVDF binder ratio with an ECA of 44-45 m²/g for nanofibers (the same ECA as a nanofiber mat cathode with Nafion®+PAA binder) vs. 34-36 m²/g for the GDE cathodes (the same ECA as a painted or decal GDE with neat Nafion® binder [2, 30]). So, the addition of PVDF to Nafion® does not change the number of active Pt sites for proton reduction (H generation) in a given fuel cell cathode structure, but nanofibers provide substantially more catalyst sites as compared to a GDE, presumably due to better distribution of catalyst and binder, coupled with the presence of intrafiber voids. At EoL, there is a substantial loss in ECA for all cathodes, with slightly less ECA loss for binders of high PVDF content. As was the case at BoL, the nanofiber morphology provides for more electrochemical surface area after carbon corrosion (i.e., the initially high ECA of nanofibers does not promote excessive carbon corrosion). A plot of % ECA loss vs. % carbon loss (shown in FIG. 9) reaffirms what was already seen in FIG. 8, that the relative deterioration of the cathode after a voltage cycling experiment is binder-composition-dependent and not a function of cathode structure (nanofiber vs. GDE). Thus, both cathode morphologies suffered equally from carbon corrosion, in terms of % ECA loss, for a given Nafion®/PVDF binder. Measured cathodic Tafel slopes were essentially the same for all MEAs, between 70-84 mV/dec, and showed no correlation with composition or structure, indicating no change in the ORR reaction mechanism for nanofiber vs. GDE cathodes.

TABLE 2
BoL and EoL Electrochemical Surface Area, Mass Activity Data, and
Tafel Slopes for MEAs with Electrospun or Painted GDE Cathodes

| | ECA | | Mass Act* | | Tafel Slope | |
|---|---|---|---|---|---|---|
| Cathode Pt/C Binder | (m²/g_{Pt}) | | (A/mg_{Pt}) | | (mV/decade) | |
| (w/w) | BoL | EoL | BoL | EoL | BoL | EoL |

Electrospun Cathodes

| | | | | | | |
|---|---|---|---|---|---|---|
| Neat PVDF | 29 | 23 | 0.051 | 0.082 | 82 | 79 |
| 20 Nafion/80 PVDF | 44 | 32 | 0.067 | 0.12 | 77 | 78 |
| 33 Nafion/67 PVDF | 45 | 33 | 0.071 | 0.12 | 82 | 76 |
| 50 Nafion/50 PVDF | 44 | 30 | 0.093 | 0.11 | 75 | 74 |
| 67 Nafion/33 PVDF | 45 | 30 | 0.11 | 0.11 | 75 | 77 |
| 80 Nafion/20 PVDF | 45 | 30 | 0.12 | 0.11 | 80 | 84 |
| 67 Nafion/33 PAA | 45 | 28 | 0.16 | 0.14 | 70 | 78 |

Painted GDE Cathodes

| | | | | | | |
|---|---|---|---|---|---|---|
| Neat PVDF | 25 | 21 | 0.035 | 0.053 | 72 | 73 |
| 20 Nafion/80 PVDF | 35 | 25 | 0.044 | 0.084 | 75 | 75 |
| 33 Nafion/67 PVDF | 34 | 25 | 0.053 | 0.079 | 84 | 79 |
| 50 Nafion/50 PVDF | 36 | 24 | 0.067 | 0.077 | 79 | 81 |
| 67 Nafion/33 PVDF | 36 | 23 | 0.081 | 0.073 | 84 | 82 |
| 80 Nafion/20 PVDF | 35 | 23 | 0.083 | 0.072 | 79 | 81 |
| 100 Nafion | 36 | 21 | 0.11 | 0.080 | 73 | 77 |

*measurements taken at 0.90 V in O₂ at 7 psi_{g} and 100% RH

In contrast to the ECA data, the mass activity of Nafion®/PVDF binder cathodes at BoL was strongly influenced by both the binder composition and cathode structures, with nanofiber activities about 40% greater than those for a GDE at the same Nafion®/PVDF weight ratio. The measured decrease in mass activity with increasing PVDF content for GDE and nanofibers at BoL (for binders with a high PVDF content) is attributed to less water at the cathode surface, which adversely affects ORR kinetics [31]. The low O₂ permeability of PVDF and the poor proton conductivity of high PVDF content blends may also be playing a role here. At EoL, the situation is much different and highly unusual, where mass activities are essentially independent of Nafion®/PVDF composition (more so for nanofibers than GDEs) and where the EoL/BoL mass activity ratio for a given binder is ≥1.0. For Nafion®/PVDF binders with more than 50 wt % PVDF, the Pt remaining after carbon corrosion is substantially more active than the Pt at BoL. This increase in activity is associated with the generation of carbon oxidation species, e.g., COOH and C═O on the catalyst support surface which makes the catalyst more hydrophilic [8]. Normally, this increase in cathode hydrophilicity is deleterious to MEA performance because it promotes excessive water retention in the cathode and flooding during EoL fuel cell operation. In the present study, however, the increase in hydrophilicity of the cathode surface for a hydrophobic Nafion®/PVDF binder is beneficial in that it improves the Pt mass-corrected EoL activity; this is true for all nanofiber cathode MEAs and some GDE cathodes. This is illustrated by a simple correction of the measured EoL mass activities in Table 2. If one assumes that the EoL to BoL ECA ratio is representative of the relative Pt mass loss after a carbon corrosion experiment, then the mass corrected EoL activity of Pt in Nafion®/PVDF nanofibers is equal to the EoL activity in Table 2 multiplied by ECA_{EoL}/ECA_{BoL}. For all of the nanofiber cathodes, this mass corrected activity is about 0.165 A/mg_{Pt}, which is close to the BoL mass activity of a nanofiber cathode with a hydrophilic Nafion®/PAA binder. A similar argument holds for the GDE MEAs with Nafion®/PVDF binders (the Pt mass-adjusted EoL activity is about 0.11 A/mg_{Pt}, i.e., the same as that for a GDE cathode with a hydrophilic neat Nafion® binder). This increase in EoL mass-corrected activity is most pronounced for high PVDF content binders, where the mass activity at BoL is very low and the root-cause for the increase in power densities after the accelerated carbon corrosion test for some Nafion®/PVDF binders, shown in FIGS. 6A-6F. The Nafion®/PVDF nanofibers cathodes of high PVDF content also have the requisite binder hydrophobicity to extract any excessive water that might be present near the catalyst, thus minimizing the usual flooding issues that accompany carbon corrosion. This point is best illustrated by examining the Nafion®/PAA nanofiber cathode MEA results in Table 2. Here, the EoL mass activity is much higher than that for any Nafion®/PVDF binder, but the EoL power is lower. This is due to the combined effects of a smaller EoL ECA and the hydrophilicity of the binder which cannot stop flooding after carbon corrosion and the formation of surface oxide species on the catalyst support.

As expected, the BoL and EoL ECAs and mass activities of MEAs with a neat PVDF cathode binder were quite low, but the measured ECAs (before and after carbon corrosion) were surprisingly similar for both nanofiber and GDE cathode structures. In both cathode structures, the available electrochemical area is limited by mobile proton access to Pt sites. The results indicate that a nanofiber morphology cannot completely counterbalance the deleterious effects of a poorly functioning cathode binder. While the ECAs of nanofibers and GDEs suffer equally from PVDF, the nanofiber morphology does produce a higher mass activity (at both BoL and EoL), is caused by better oxygen transport in a fiber, i.e. a thinner and more uniform coating of PVDF on catalyst particles.

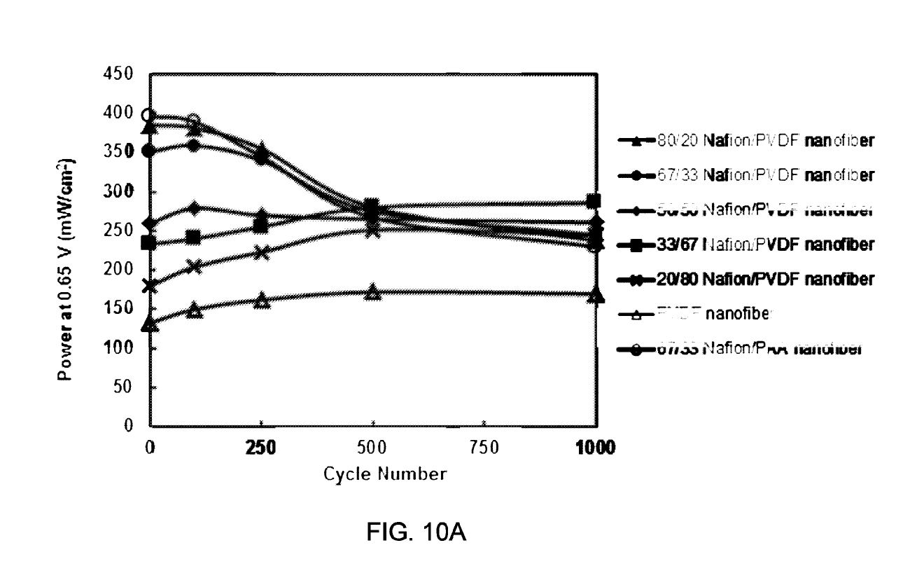

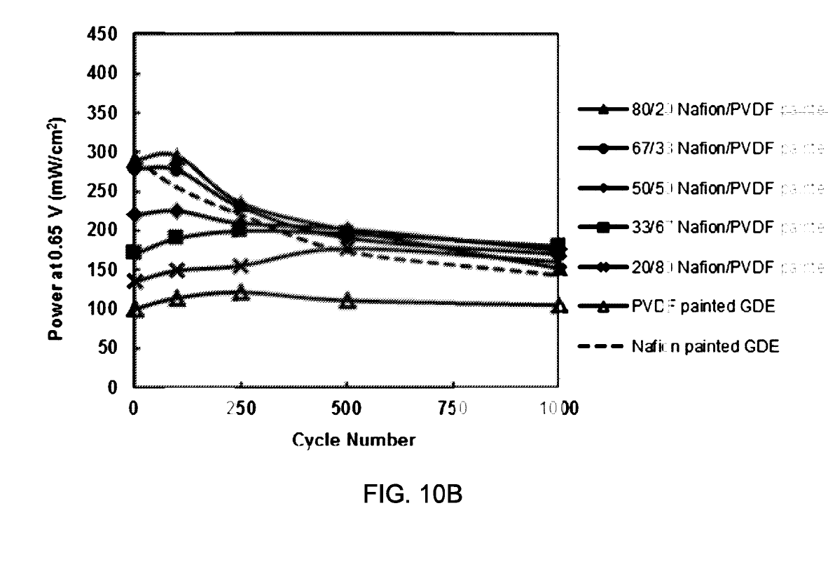

Intermittent polarization curves at 100% RH were collected during the corrosion tests to determine how power densities varied with cycle number. The resulting power densities at 0.65 V for nanofiber and GDE cathode MEAs are shown in FIGS. 10A and 10B, respectively. The rate at which MEA power density changed with cycle number was affected by both binder composition and cathode morphology. Most of the power losses or gains occurred during the first 500 voltage cycles. Power densities vs. cycle number curves for the painted and nanofiber cathode MEAs were qualitatively similar for a given cathode binder composition, with the painted MEAs producing much less power. Nanofiber cathode MEAs with 50/50 Nafion®/PVDF binder showed essentially no change in power density for 1,000 voltage cycles. This flat power density vs. cycle number curve may have important benefits when using inexpensive non-PGM cathode catalysts, where one can compensate for a low power density (due to the presence of PVDF) by increasing the cathode catalyst loading.

Low Humidity Fuel Cell Operation—

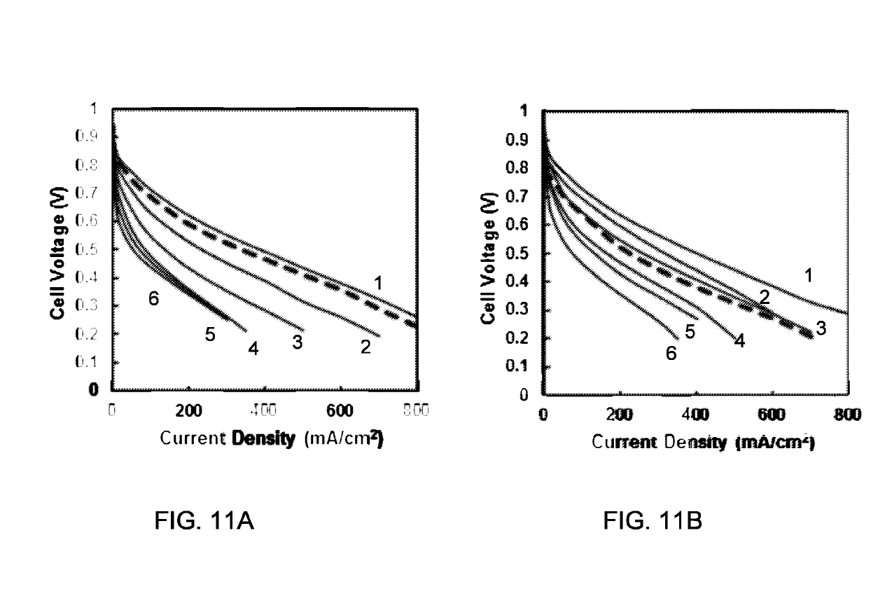

BoL and EoL polarization data with Nafion®/PVDF MEAs were collected at 40% RH feed gas condition, where the carbon corrosion test was performed under standard conditions with fully humidified feed gases. The results are shown in FIG. 11A and FIG. 11B. The performance of the Nafion®/PVDF cathode binder MEAs was inversely proportional to the binder PVDF content, i.e., less current (less power) was generated over the entire voltage range as the PVDF content increased (see FIG. 10A). At BoL and 40% RH, only the Nafion®/PVDF nanofiber with the smallest amount of PVDF (20 wt % of the cathode binder) worked better than a conventional Nafion® GDE. This same trend was seen with fully humidified feed gases, although the activation/kinetic and ohmic losses are more severe at low humidity. Not surprisingly, the deleterious effects of cathode drying at low feed gas RH are exacerbated as the cathode binder becomes more hydrophobic. The performance of MEAs with little or no Nafion® in the cathode (0 and 20 wt % Nafion®) were particularly poor, e.g., the neat PVDF MEA produced only 7 mW/cm² at 0.65 V and 76 mW/cm² at maximum power at 40% RH and H₂/air at ambient pressure. These results were not unexpected and are qualitatively similar to that observed with 3M Company's NSTF platinum whisker cathodes, e.g., a power loss of about 70% at 0.8 V when the H₂/O₂ feed gas RH is decreased from 100% RH to 50% RH [26]. One would expect that power losses could be partially mitigated if the hydrophilicity of the cathode was increased and this appears to be the case in the present study, as shown by the EoL data in FIG. 7B. Indeed, after a voltage cycling carbon corrosion test, the nanofiber Nafion®/PVDF polarization curves shift upward, due presumably to the presence of surface carbon oxidation species on the catalyst support which makes the cathode more hydrophilic.

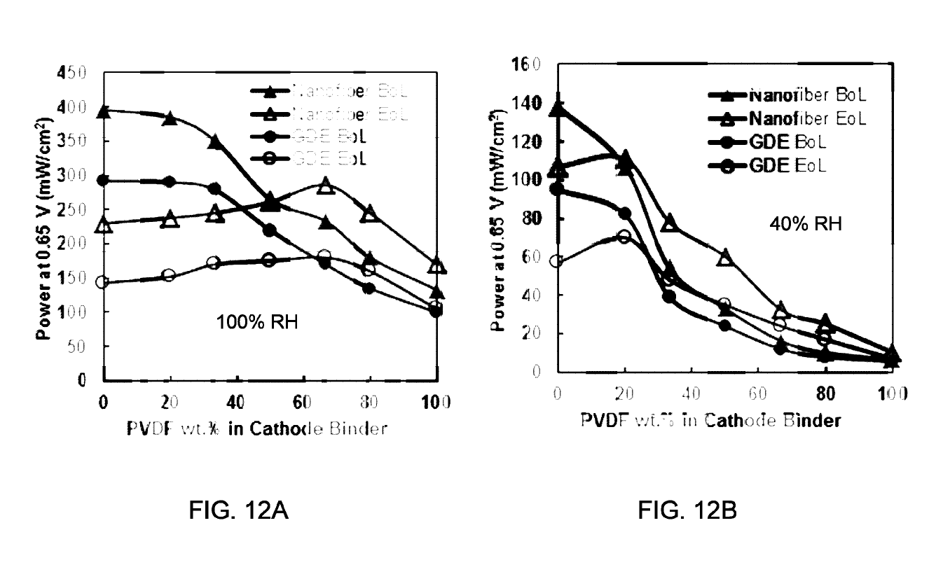

Power output results at 0.65 V and 100% RH and 40% RH are summarized in FIGS. 12A and 12B for all nanofiber and GDE cathode MEAs. These data highlight the benefit of a nanofiber morphology with Nafion®/PVDF binders, i.e., at the same binder composition, BoL power densities with nanofiber PVDF/Nafion® MEAs are higher than those with a GDE MEA. Furthermore, at EoL with fully humidified feed gases, all nanofiber cathode MEAs worked better than all GDE cathode MEAs, regardless of binder type (i.e. electrode morphology dominates over the Nafion®/PVDF binder composition). At BoL, the best nanofiber cathode contained a binder of either 67/33 Nafion®/PAA or 80/20 Nafion®/PVDF. The best binder at EoL was 33/67 Nafion®/PVDF (at EoL, this nanofiber cathode MEA produced 79% more power at 0.65 V than the best GDE cathode MEA). At 40% RH feed gases, only the Nafion®/PAA and 80/20 Nafion®/PVDF binders worked well at EoL.

In brief, a series of nanofiber and GDE cathode MEAs were fabricated and tested, where the cathode catalyst was Johnson-Matthey Pt/C and the binder was either a mixture of Nafion® and PVDF or neat PVDF. The intended goal of this work was to increase the hydrophobicity of the cathode, thereby changing the water content at the catalyst surface and decreasing the extent of carbon corrosion after an accelerated voltage cycling experiment. Electrospun nanofiber mats were fabricated with 70% Pt/C catalyst and 30% Nafion®/PVDF binder, where the PVDF content in the binder was varied from 20% to 80 wt %; a neat 30 wt. % PVDF binder was also examined. The mats were incorporated as the cathode in MEAs, where the anode and cathode Pt loading were each 0.1 mg/cm² and where the anode for all MEAs was an electro spun fiber anode (0.1 mg_{Pt}/cm² with a binder of Nafion® and poly(acrylic acid).

General conclusions that apply to both nanofiber and painted GDE cathode MEAs are as follows: (1) beginning-of-life (BoL) power output decreased with increasing PVDF content; this was associated with the low proton conductivity of PVDF, less water at the catalyst surface with increasing PVDF (which adversely affect ORR kinetics), and/or the low O₂ permeability of PVDF as compared to wet Nafion®, (2) after 1,000 voltage cycles (1.0 to 1.5 V), the % cathode carbon loss was identical for the two cathode structures, where carbon loss decreased linearly with increasing PVDF content, thus carbon corrosion was suppressed by limiting the water content in the binder near the catalyst surface, (3) the relative change in electrochemical surface area (ECA) with % cathode carbon loss after voltage cycling was the same for the two structures, thus the initial higher ECA advantage of the nanofiber morphology vs. a conventional GDE was maintained after carbon loss, and (4) the change in power density at EoL with Nafion®/PVDF binder content was qualitatively similar for nanofibers and painted GDE cathodes, with a decrease in power after voltage cycling when the binder contained <50% PVDF and an increase in EoL power densities when the binder contained >50% PVDF. The last two conclusions indicate that PVDF was playing a major role in altering the hydrophobic/hydrophilic conditions at the catalyst surface and in doing so altered not only the carbon corrosion rate but also the mass activity of the Pt that remained after corrosion.

The following differences in the two MEA morphologies (nanofiber vs. GDE) were also dramatically evident from the experimental results: (1) Nanofiber cathode MEAs always produced higher power densities for all voltages both before and after carbon corrosion at a given Nafion®/PVDF binder composition; this result is consistent with that found in prior studies with a cathode binder of Nafion®+poly(acrylic acid), (2) the ECA and mass activity of nanofiber cathodes were always greater than those for a GDE cathode for the same binder composition at both BoL and EoL; this is due to the unique morphology of a nanofiber electrode, where there is interfiber and intrafiber porosity and a very thin and uniform coating of binder on all catalyst sites for facile transport of reactants and products.

Conclusions specifically targeted to nanofiber cathode MEAs are as follows: (1) a 80/20 Nafion®/PVDF binder nanofiber cathode MEA generated the highest maximum power at BoL: 545 mW/cm² at 80° C., 100% RH and ambient pressure, which was 35% higher than a conventional GDE cathode MEA with neat Nafion® and 13% higher than a nanofiber cathode MEA with a binder of Nafion®+poly(acrylic acid), (2) surprisingly, a nanofiber cathode with neat PVDF binder produced reasonably high power densities (a maximum of 291 mW/cm²); it is not clear at the present time if only fibers/catalyst in contact with the membrane were electrochemically active or if there was some proton migration, perhaps, along the catalyst surface which produced the better-than-expected power densities, (3) at BoL for Nafion®/PVDF binders, there was a significant decrease in MEA power output with PVDF content due to changes in cathode mass activity and not due to changes in ECA, (4) at EoL, power did not correlate with the PVDF content of Nafion®/PVDF binders and differences in power with binder composition were much less dramatic than at BoL, (5) nanofiber cathode power densities at EoL for binders with <50% PVDF decreased vs. BoL due to a decrease in ECA which overwhelmed a small increase in the mass activity of Pt material remaining after carbon corrosion, Although the nanofiber morphology itself assists in water removal from the cathode, the hydrophilicity of the binder was unable to effectively repel/extract water from the surface-oxidized catalyst, thus flooding may also have affected power and (6) the EoL power density increases for binders with >50% PVDF is attributed to the combined effects of slightly less carbon corrosion and ECA loss (less water near the catalyst at the beginning of the voltage cycling experiment), a dramatic increase in the Pt mass activity due to the formation of hydrophilic chemical oxidation species on the carbon support, and the presence of hydrophobic binder which in combination with the nanofiber morphology continuously facilitated water extraction from the catalyst surface, thereby minimizing the deleterious effects of flooding, (7) at BoL and 40% RH, only the Nafion®/PVDF nanofiber with the smallest amount of PVDF (20 wt % of the cathode binder) worked better than a conventional Nafion® GDE; at EoL and 40% RH, Nafion®/PVDF nanofiber MEAs with a Nafion® content >50% out-performed a GDE cathode, (8) a nanofiber MEA with a 33/67 Nafion®/PVDF cathode binder produced the highest power at EoL, 286 mW/cm² at 0.65 V, and (9) for a 50/50 Nafion®/PVDF cathode binder MEA, the BoL and EoL power densities (and power densities measured intermittently between BoL and EoL during a voltage cycling experiment) were essentially unchanged (260 vs. 261 mW/cm² at BoL and EoL, respectively), indicating that the increase in Pt mass activity due to a steady increase in the hydrophilicity of the catalyst matched the gradual/continuous loss in ECA during voltage cycling, where the hydrophobic character of the binder prevented excessive water buildup. This binder may be ideally suited to non-PGM catalyst powers which are prone to degradation and where the low power due to the presence of PVDF can be offset by the use of thick, high loading cathodes. Such experiments are currently underway and will be the subject of a future publication. Also, it is important to note that the carbon corrosion tests were not extended in the present study beyond 1,000 cycles, so it is not known if high PVDF content cathodes will eventually show a power decline with cycle number as the cathode surface becomes increasingly hydrophilic and begins to replicate a high Nafion® content blended binder, where power decreases with voltage cycling.

### Example 2

### Nanofiber Cathodes for Hydrogen/Air Fuels with Pt-Alloy Catalyst

In this example, electrode binders of PVDF or blends of Nafion® and PVDF are disclosed, and new cathode catalysts PtCo with Nafion® and poly(acrylic acid) binder is introduced.

Electrospinning Fuel Cell Catalyst into a Nanofiber Electrode Mat:

In certain embodiments, a method of electrospinning fuel cell catalyst into a nanofiber electrode mat is provided. In one example, a polymeric solution is pumped through a needle spinneret which is subjected to a high bias voltage. When the electrostatic repulsion forces overcome surface tension effects, a Taylor cone is created at the needle tip. A fiber jet emerges from the Taylor cone and travels to a grounded collector drum, during which time solvent evaporates from the jet. Then the high molecular weight polymers with sufficient chain entanglements will form fiber structures that dry-deposit on a grounded collector.

In certain embodiments, to electrospin Nafion®, poly(acrylic acid) (PAA) was added to the spinning solution as a carrier polymer. For the Nafion®/PAA binder, the electrospinning solvent was a n-propanol/water mixture. The ink thus includes catalyst such as Pt/C, Nafion®, and PAA. The ink is then electrospun as described above onto a collector such as an aluminum foil, so as to form a nanofiber mat. The nanofiber mat is hot press on PEM to form CCM.

Properties of Nafion®/PAA Binder:

In certain embodiments of the present invention, a particle/polymer nanofiber cathode performs exceptionally well as a cathode in a H₂/air fuel cell, where the cathode has low Pt loading (0.05-0.10 mg/cm²) and excellent long-term durability (after accelerated carbon corrosion tests). In certain embodiments, commercial Pt/C catalyst (Johnson-Matthey and TKK) is mixed with a Nafion®+poly(acrylic acid) (PAA) binder for manufacturing the nanofiber contained in the cathode. In certain embodiments, the nanofiber composition includes 65-72 wt. % Pt/C, 13-23 wt. % Nafion®, and 12-15 wt. % PAA.

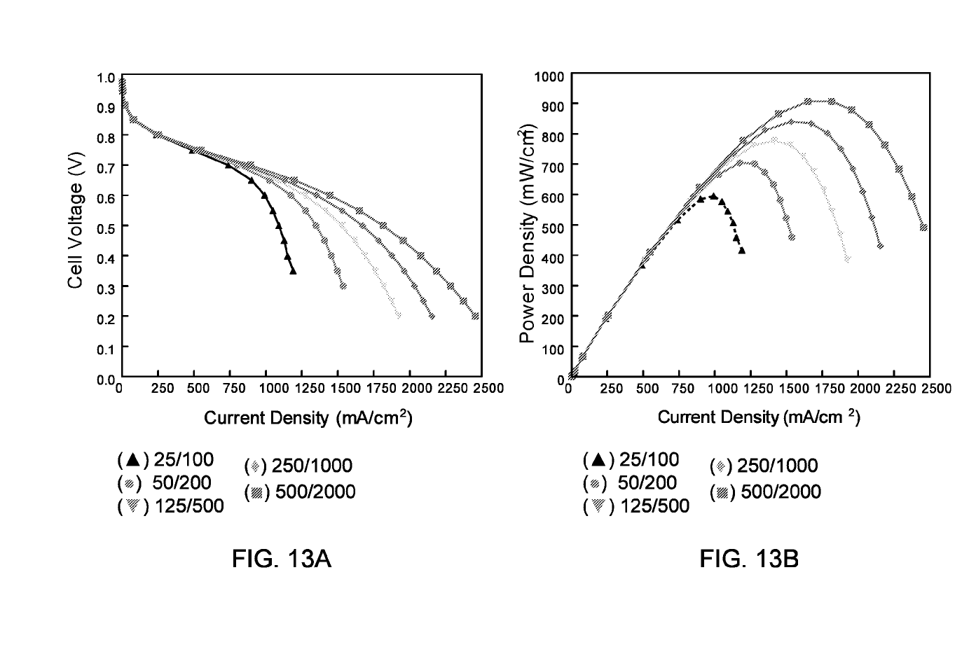

FIGS. 13A and 13B show nanofiber electrode fuel cell performance with a Nafion®/PAA binder. In this example, the electrode includes a Nafion® 212 membrane, an electrospun 0.055 mgPt/cm² cathode, and an electrospun 0.059 mgPt/cm² anode. The flow rates are respectively 25/100, 50/200, 125/500, 250/1000 and 500/2000 sccm H₂/sccm air, under 100% RH, 80° C., and 2 atm backpressure. As shown in FIG. 13B, a very high power density (max at 906 mW/cm²) was achieved at low Pt loading. Based on these results, the total (anode+cathode) Pt loading of MEAs for an 80 KW fuel cell stack is only 10.0 g. Further, at high current densities (>2 A/cm²), there is no indication of oxygen mass transfer limitations or water flooding.

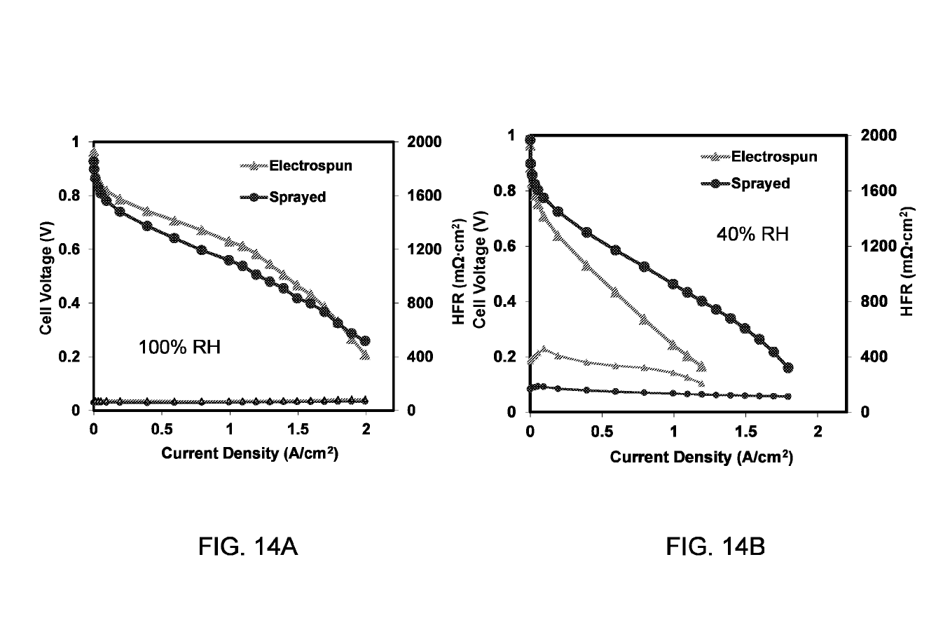

FIGS. 14A and 14B show initial FC Performance of nanofiber cathode vs Nissan sprayed GDE (Nissan Technical Center North America—Taehee Han, Nilesh Dale, Ellazar Niangar). In the example shown in FIGS. 14A and 14B, the MEAs includes 0.10 mg_{Pt}/cm² cathode and anode with JM HiSpec 4000 Pt/C catalyst, Nafion® 211, 25 cm². The operating conditions are: 80° C., 1 bar_{g}, 8000 sccm air and 4000 sccm H₂ (straight flow channels). The results show that nanofiber electrode MEA had better performance at 100% RH. Nanofiber ECA was also higher (64 vs 50 m2/gPt). Nanofibers may expel product water faster, which leads to membrane drying and higher ohmic resistance during low humidity operation. Carbon corrosion test was performed under conditions of: start-stop cycling protocol with 1,000 cycles, triangular wave, and 500 mV/s cycling between 1.0 and 1.5 V.

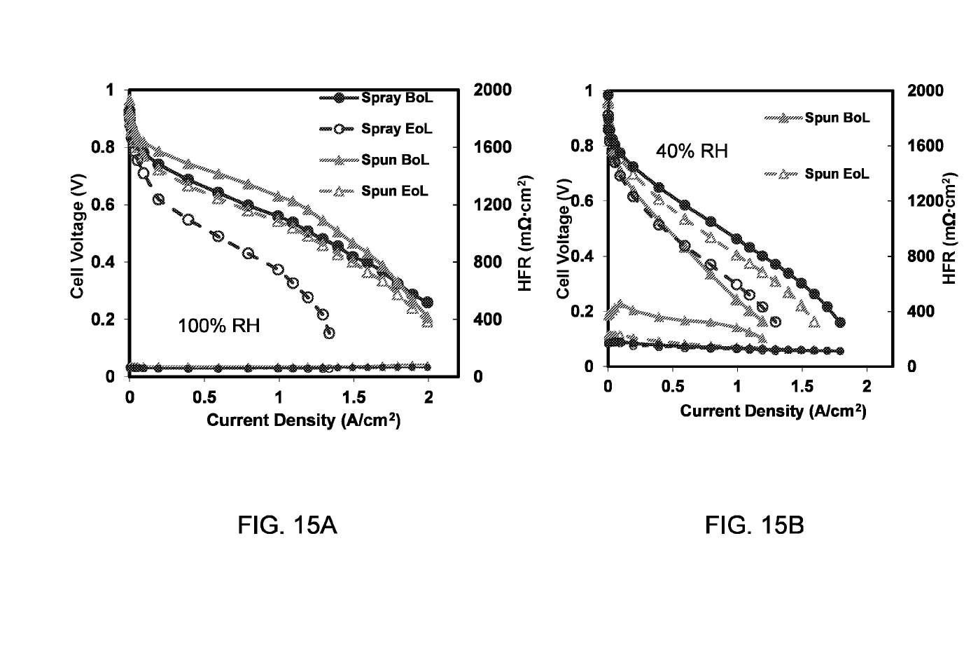

FIGS. 15A and 15B show comparison of nanofiber and sprayed electrode MEAs (from Nissan) based on beginning and end of life FC performance. In this example, the MEAs includes 0.10 mg_{Pt}/cm² cathode and anode with JM HiSpec 4000 Pt/C catalyst, Nafion® 211 membrane, 25 cm², and the tests were performed under 80° C., 1 bar_{g}, 8000 sccm air and 4000 sccm H₂ (straight flow channels). The nanofiber electrodes had a composition of 72 wt. % Pt/C, 13 wt. % Nafion®, and 15 wt. % PAA. Sprayed GDE electrodes from Nissan Technical Center North America had a neat Nafion® binder. The Start-Stop cycling protocol is: 1,000 cycles, triangular wave, 500 mV/s cycling between 1.0 and 1.5 V, (Carbon Corrosion Test).

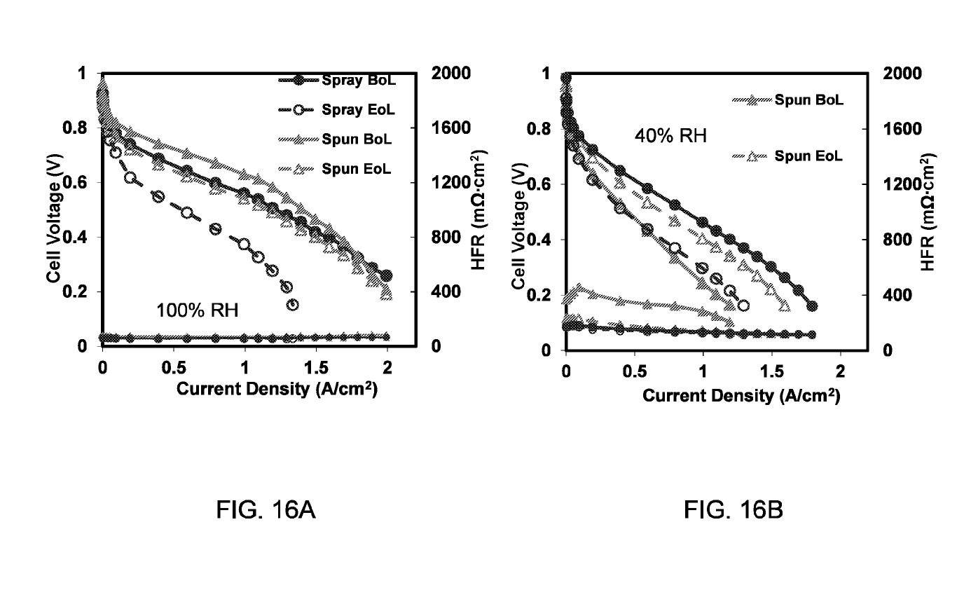

FIGS. 16A and 16B show comparison of nanofiber and sprayed MEAs based on beginning and end of life FC Performance. As shown in FIGS. 16A and 16B, nanofiber electrode MEA had better performance at 100% RH. Nanofiber ECSA was also 28% higher. Nanofibers expel product water faster, leading to membrane drying and higher ohmic resistance during low humidity operation with high flow rate feed gasses. At EoL100% RH, nanofiber MEA showed less of a decrease in power. The nanofiber electrode MEA maintained 53% of BoL power at 0.65 V and 85% of BoL max power vs. 28% at 0.65 V and 59% max power for the sprayed electrode MEA. At EoL 40% RH, nanofiber electrode MEA generated more power than at BoL due to increased hydrophilicity of the carbon support (due to the presence of carbon oxygen species).

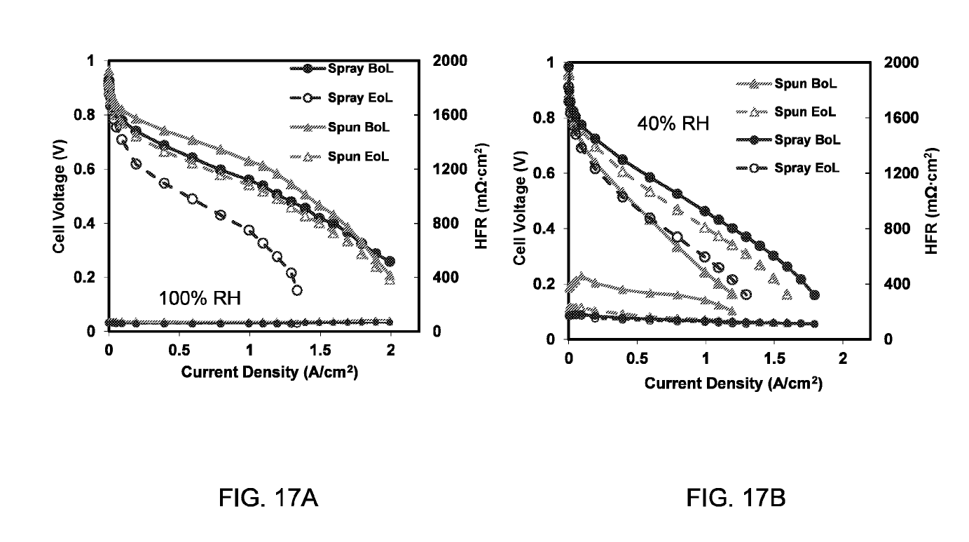

FIGS. 17A and 17B show end of life FC Performance after Start-Stop Cycling (Carbon Corrosion Test at NTCNA—1,000 cycles, 1.0-1.5 V at 500 mV/s). As shown in FIGS. 17A and 17B, at 100% RH, the nanofiber electrode MEA did not experience severe flooding at EoL like the spray GDE MEA. The nanofiber electrode MEA maintained 53% power at 0.65 V and 85% max power vs 28% at 0.65 V and 59% max power for the spray electrode MEA. At 40% RH, the nanofiber electrode MEA actually improve due to more optimal hydration as seen by a reduction in HFR. The nanofiber cathode showed similar carbon mass loss (20%) and ECA loss (40%) as the sprayed cathode; nanofiber cathodes are able to withstand carbon corrosion without severe loss in performance.

Properties of Nafion®/PVDF Binder:

In certain embodiments of the present invention, a PVDF binder and a blends of Nafion® and PVDF are provided. PVDF is stable in a fuel cell environment, it is inexpensive, and it can be electro spun. In certain embodiments, the PVDF used is Kynar® HSV 900. PVDF is stable in the presence of platinum and electro spinning inks should have a long shelf life. PVDF is hydrophobic, which should reduce the amount of water near the carbon support and slow/stop carbon corrosion:

C+2H₂O→CO₂+4H⁺+4e⁻

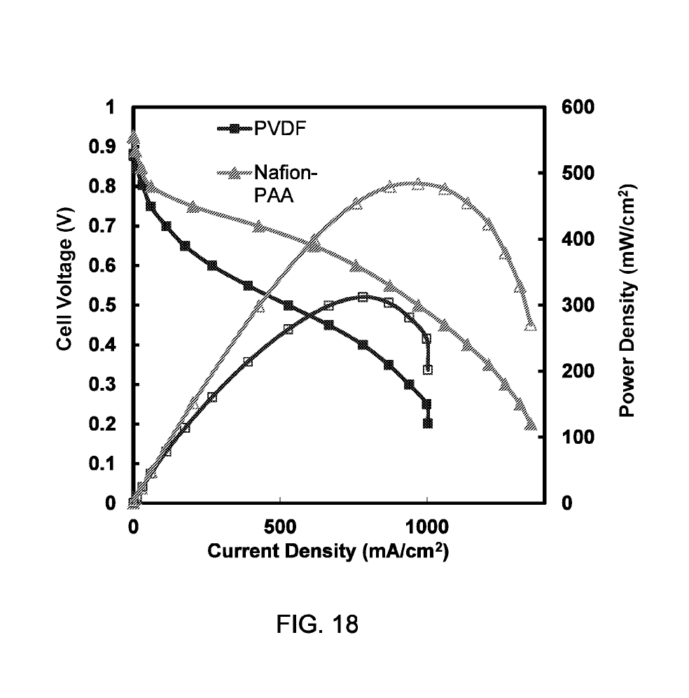

FIG. 18 shows comparison of PVDF as a binder and Nafion®/PAA as a binder. The cathode Pt loading with PVDF binder was 0.14 mg/cm²; Nafion®/PAA binder cathode had a Pt loading of 0.10 mg/cm². All electrodes are electrospun. The operation condition is under 80° C., 100% RH, Nafion® 211, ambient pressure air and H₂. As shown in FIG. 18, at 0.65 V, the MEA with PVDF-based cathode produced about 35% of the power density of the normal Nafion®/PAA electrospun electrode, but it produced 65% of the maximum power density despite having no ionomer in the cathode.

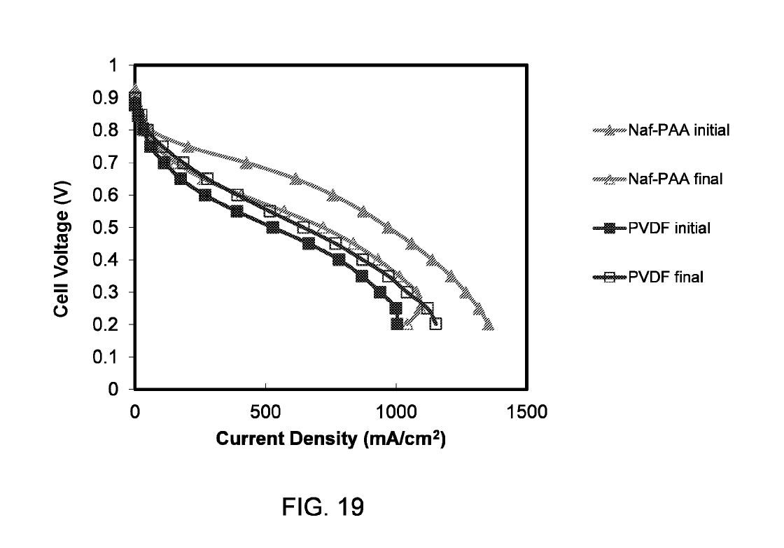

FIG. 19 shows comparison of Nafion®/PAA and PVDF as the cathode binder based on the FC performance before/after carbon corrosion test. The Start-Stop cycling protocol is: 1,000 cycles, triangular wave, and 500 mV/s cycling between 1.0 and 1.5 V. As shown in FIG. 19, the performance of the PVDF MEA improved after the carbon corrosion test, which may due to more optimal hydration (oxidation of the carbon catalyst). After the carbon corrosion protocol (1,000 cycles), the final i-V performance of MEAs with Nafion®/PAA and PVDF cathodes was similar. It indicated that if the initial performance of the Pt/C cathode with PVDF could be improved, then this polymer could be a viable electrode binder.

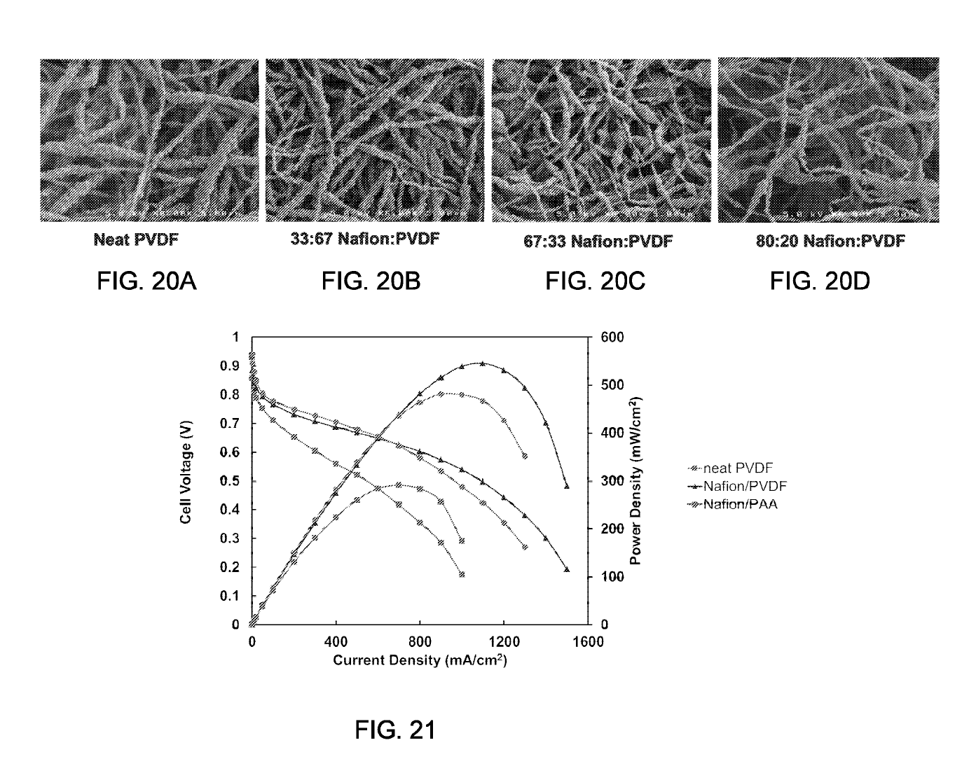

FIGS. 20A-20D show PVDF and Nafion®/PVDF as a cathode binder for Pt/C nanofibers. In certain embodiments, nanofiber mats could be electrospun from Nafion®/PVDF blends, where the PVDF content is varied between 5 wt. % and 80 wt. %. These nanofiber mats were converted into dense membranes. In certain embodiments, nanofiber mat electrodes were produced, which were electrospun from various blends of Nafion® and PVDF. All the mats shown in FIGS. 20A-20D include 70 wt % of catalyst and 30 wt % total binder.

FIG. 21 shows FC Performance with PVDF, Nafion®/PVDF, and Nafion®/PAA binders. The tests were performed under 80° C., 500 sccm air and 125 sccm H₂ (ambient pressure), 100% RH. The Nafrion/PVDF has a Nafion®:PVDF ratio of 80:20. The material includes 0.10 mg_{Pt}/cm² cathode and anode (all anodes have Nafion®/PAA binder), Nafion® 211 membrane, 5 cm² MEA. As shown in FIG. 21, the cathode with neat PVDF generated lower power over the entire voltage range, but the measured current densities were still significant. Cathode with Nafion®/PVDF generated slightly lower power at voltages ≥0.65 V and higher power at voltages ≥0.65 V, resulting in 12% higher maximum power for Nafion®/PVDF, as compared to Nafion®/PAA.

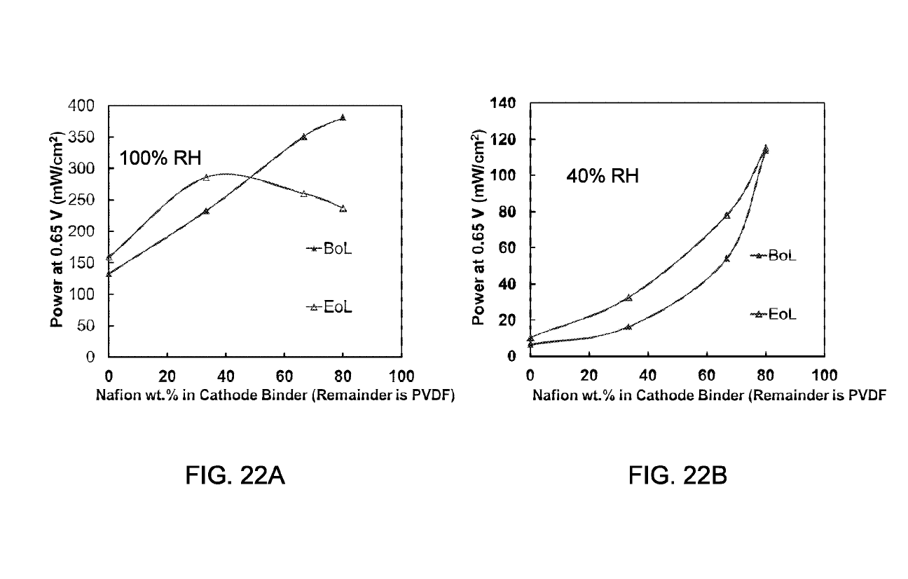

FIGS. 22A and 22B show BoL and EoL power for Nafion®/PVDF binders. In this example, the operations conditions is: 80° C., 100% RH, H₂ at anode, N₂ at cathode, and 1,000 cycles between 1.0 V and 1.5 V (carbon corrosion test). As shown in FIGS. 22A and 22B, the optimum binder at 100% RH and 40% RH at BoL was 80:20 Nafion®:PVDF. The optimum binder at 100% RH at EoL was 33:67 Nafion®:PVDF.

The optimum binder at 40% RH at EoL was 80:20 Nafion®:PVDF. Further, for comparison with a Nafion®:PAA binder, BoL and EoL power densities at 0.65 V are 396 and 230 mW/cm² at 100% RH and 156 and 162 mW/cm² at 40% RH (Nafion®/PAA does better at BoL and at low RH).

Table 3 as follows shows FC performance with PVDF, Nafion®/PVDF, and Nafion®/PAA binders.

TABLE 3
FC performance with PVDF, Nafion ®/PVDF,
and Nafion ®/PAA binders

| | | | Mass Act* | Mass Act* |
|---|---|---|---|---|
| Binder | ECA (BoL) | ECA (EoL) | (BoL) | (EoL) |
| Composition | (m²/mg_{Pt}) | (m²/mg_{Pt}) | (A/mg_{Pt}) | (A/mg_{Pt}) |
| Neat PVDF | 33 | 26 | 0.051 | 0.092 |
| 33 Nafion:67 PVDF | 45 | 33 | 0.071 | 0.12 |
| 67 Nafion:33 PVDF | 45 | 30 | 0.11 | 0.11 |
| 80 Nafion:20 PVDF | 46 | 30 | 0.12 | 0.11 |

As shown in Table 3, neat PVDF and Nafion®/PVDF binders all had a high BoL ECA, as compared to their EoL ECA. Binders with more Nafion® lost a higher percentage of ECA. For example, neat PVDF lost 21%, 33:67 Nafion®:PVDF lost 27%, and 80:20 Nafion®:PVDF lost 35%. Neat PVDF and 33:67 Nafion®:PVDF experienced an increase in mass activity at EoL, due presumably to more optimal hydrophilic conditions for cathodic oxygen reduction.

Properties of PtCo Catalyst:

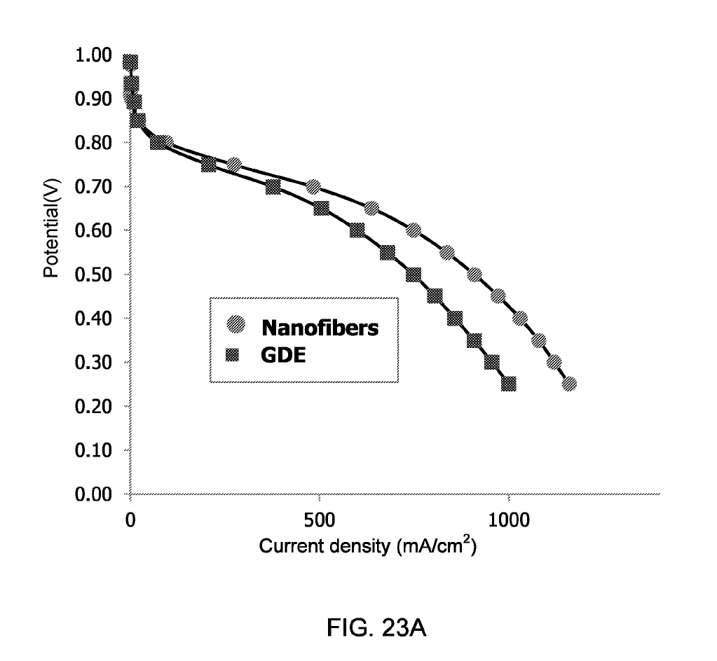

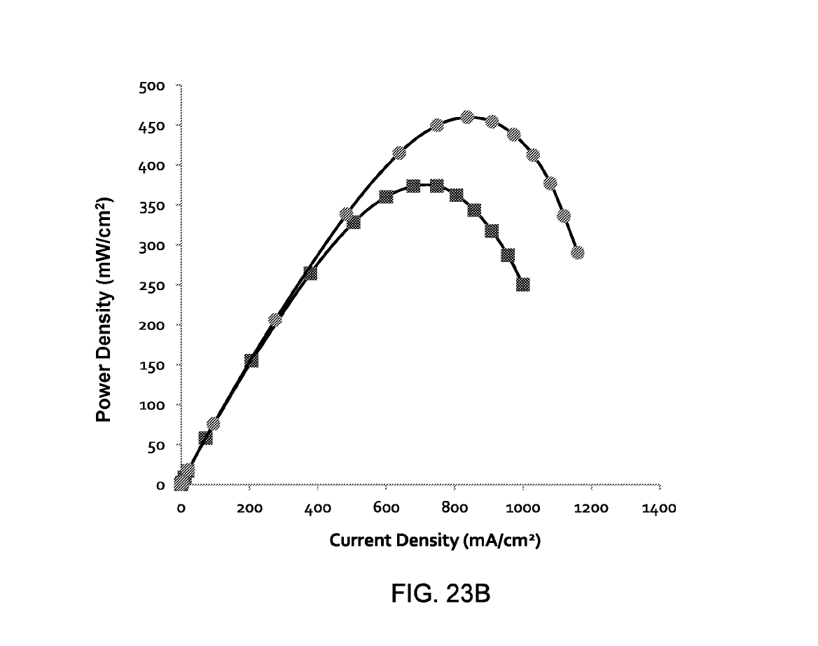

In certain embodiments of the present invention, a PtCo catalyst is provided. FIGS. 23A and 23B show PtCo nanofiber vs. GDE cathode, where the catalyst is PtCo on acetylene black (5 wt. % Co). Fuel cell operating conditions are as follows: anode hydrogen at 125 sccm; cathode air at 500 sccm; ambient pressure; cell temperature 80° C.; relative humidity 100%; Pt loading: 0.1 mg/cm² (for anode and cathode); nanofiber composition (anode and cathode): 63 wt. % catalyst, 22 wt. % Nafion®, and 15 wt. % PAA. As shown in FIGS. 23A and 23B, there is a 23% improvement in max power, as compared to a conventional GDE for the Pt(Co) cathode catalyst (same improvement as with a Pt/C catalyst).

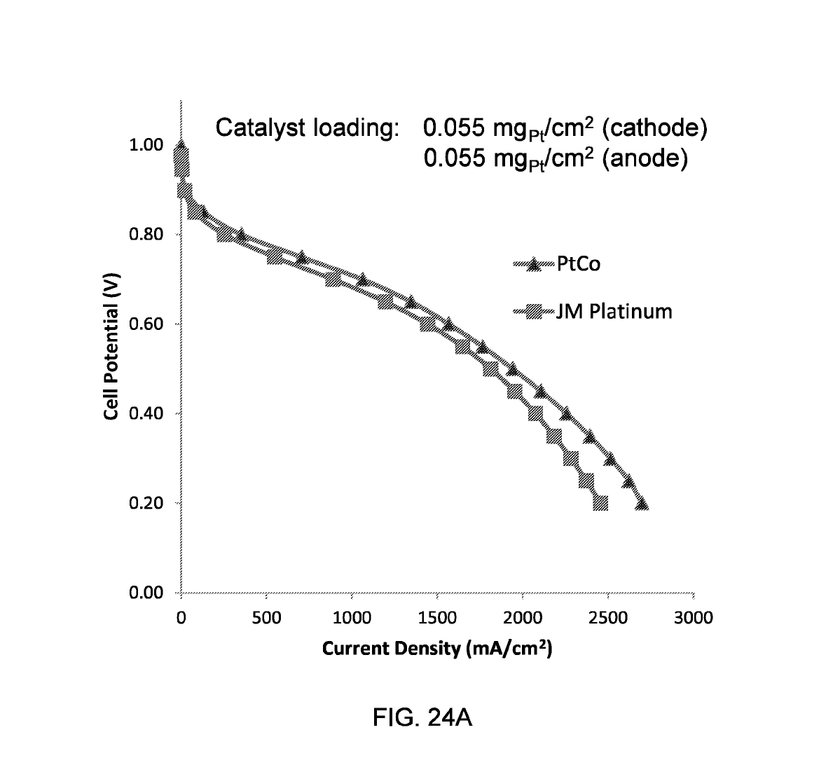

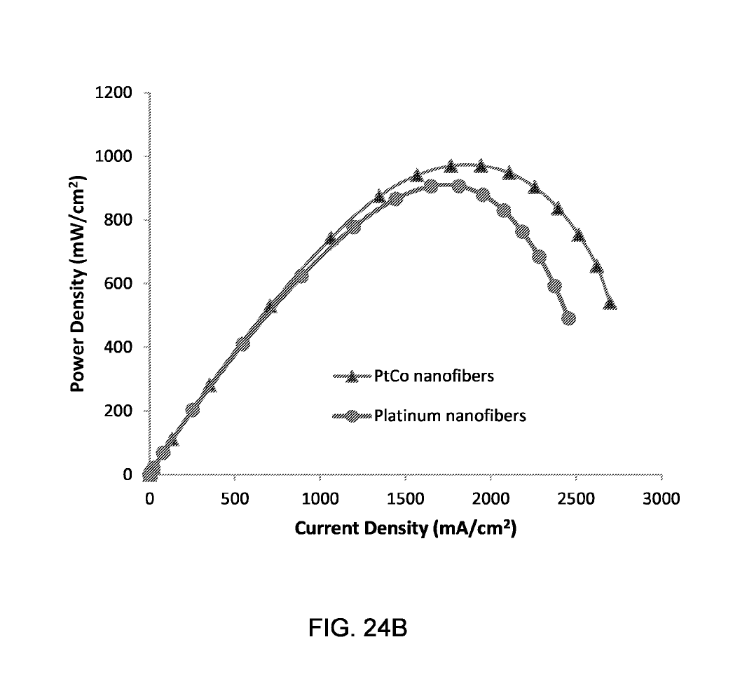

FIGS. 24A and 24B show comparison of Johnson-Matthey Pt/C vs. PtCo nanofiber cathodes. Fuel cell operating conditions are as follows: anode hydrogen at 500 sccm; cathode air at 200 sccm; 2 atm back pressure; temperature: 80° C.; relative humidity: 100%; nanofiber cathode composition (anode and cathode): 63 wt. % catalyst, 22 wt. % Nafion®, and 15 wt. % PAA. As shown in FIGS. 24A and 24B, the max power (mW/cm2) for PtCo is 970, and for JM Pt is 906. The power at 0.65 V (mW/cm²) for PtCo is 875 and for JM Pt is 777.

In sum: 1. MEAs with a nanofiber cathode and anode, Pt/C catalyst, and Nafion®/PAA binder, generated more power than Nissan MEAs (with sprayed GDEs) at 100% RH at a low Pt loading of 0.10 mgPt/cm². Nanofiber MEAs had better EoL at both 100% RH and 40% RH due to improved transport properties.

2. MEAs with nanofiber mat cathodes containing neat PVDF as the binder (no ionomer) produced significant power. EoL power was greater than BoL power.

3. A blend of Nafion® and PVDF is an effective binder for nanofiber cathodes at 100% RH. 80:20 Nafion®:PVDF generated very high power at BoL (higher max power than nanofiber Nafion®/PAA) while still having excellent EoL performance (much better than conventional sprayed cathodes). 33:67 Nafion®:PVDF generated the highest EoL power of any cathode tested.

4. Nanofiber cathodes with PtCo on acetylene black produced more power than a Pt/C cathode. A 23% improvement in power output in going from a conventional GDE to a nanofiber electrode morphology.

5. An overall comparison of nanofiber mat electrodes vs. conventional GDEs with a Nafion® binder and Pt/C catalyst for optimal BoL and EoL power (FC Operating Conditions: 80° C., 100% RH, 500 sccm air, 125 sccm H2, ambient pressure):

TABLE 4

| | Optimal | Nanofiber | Painted GDE | |
|---|---|---|---|---|
| | Nanofiber | Power | Power | |
| | Composition | Density | Density | Nanofiber/GDE |
| | (wt. %) | (mW/cm²) | (mW/cm²) | Power Ratio |
| Max BoL | 72% Pt/C + | 396 | 285 | 1.39 |
| Power at | 13% Nafion + | | | |
| 0.65 V | 15% PAA | | | |
| Max BoL | 70% Pt/C + | 545 | 400 | 1.36 |
| Power | 24% Nafion + | | | |
| | 6% PVDF | | | |
| Max EoL | 70% Pt/C + | 286 | 150 | 1.93 |
| Power at | 10% Nafion + | | | |
| 0.65 V | 20% PVDF | | | |
| Max EoL | 70% Pt/C + | 459 | 326 | 1.41 |
| Power | 10% Nafion + | | | |
| | 20% PVDF | | | |

### Example 3

### Dual Nanofiber Electrospun Fuel Cell Electrode Mats-Cathodes with Nafion® Fibers and Catalyst/Binder Fibers

In this example, Nanofiber fuel cell electrode mats with (1) Nafion nanofibers and (2) Pt/C-bound-poly(vinylidene fluoride), henceforth abbreviated as PVDF, were prepared by simultaneously electrospinning fibers from two separate spinnerets. Nanofiber mat electrodes were incorporated into membrane electrode assemblies (MEAs) and tested in a hydrogen/air fuel cell. Experimental details are described as follows.

Procedure: Preparing Inks and Electrospinning Fibers:

Electrospinning inks for Nafion® nanofibers were prepared by mixing in a 2:1 n-propanol/water solvent: (a) Nafion® ion exchange resin, and (b) and 400 kDa poly(ethylene oxide) (PEO). The Nafion®:PEO wt. ratio was 100:1. The total polymer content of the spinning suspension was 12 wt %. The mixture was mechanically stirred for approximately 24 hours.

Electrospinning inks for catalyst/PVDF nanofibers were prepared by mixing in a 3:7 DMF/acetone solvent: (a) Johnson Matthey Company HiSpec™ 4000 (40% Pt on Vulcan carbon) and (b) Kynar HSV 900 polyvinylidene fluoride. A suspension of catalyst was first sonicated for 90 minutes with intermittent mechanical stirring before the addition of PVDF. The entire mixture was then mechanically stirred for approximately 15 hours. The total polymer and powder content of the spinning suspensions was 10 wt %, and the Pt/C:PVDF weight ratio of a dry mat contained 75 wt % Pt/C, and 25 wt % PVDF.

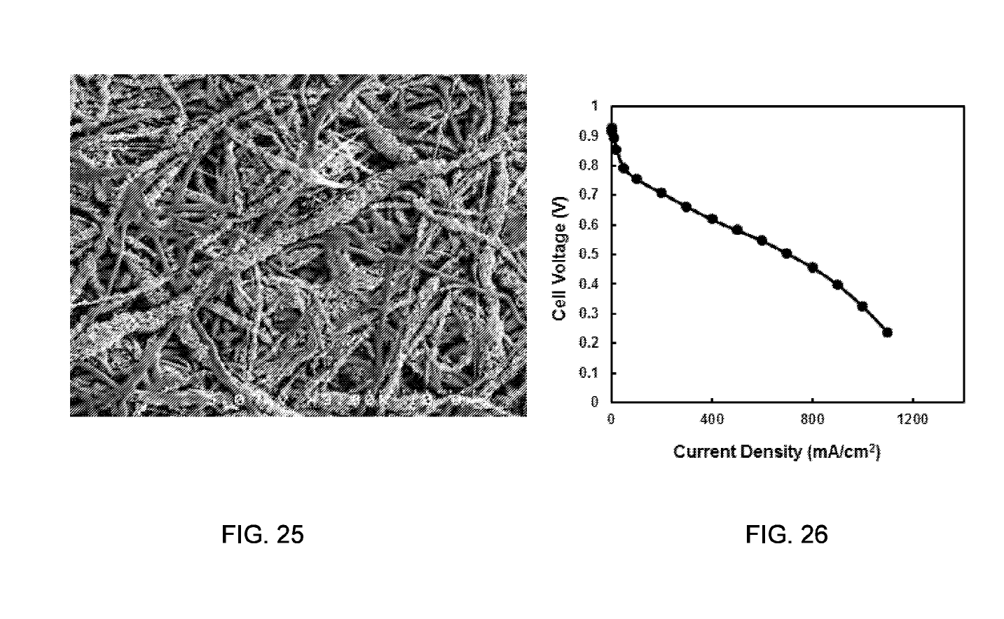

The inks were drawn into a 3 mL syringe and electrospun using a 22-gauge stainless steel needle spinneret, where the needle tip was polarized to a potential of 4.1 kV for the Nafion® containing ink and 12 kV for the PVDF containing ink relative to a grounded stainless steel rotating drum collector that was operated at a rotation speed of 100 rpm. The spinneret-to-collector distance was fixed at 6.5 cm for the Nafion® based ink and 10 cm for the PVDF based ink. The flow rate of the Nafion® ink was 0.3 mL/h and the flow rate of the PVDF ink was 1.0 mL/h. Nanofibers of both inks were collected simultaneously on aluminum foil that was attached to the cylindrical collector drum. The drum also oscillated horizontally to improve the uniformity of deposited nanofibers. Electrospinning was performed at room temperature in a custom-built environmental chamber, where the relative humidity was maintained at 60%. A top-down SEM image of an electrospun mat containing dual spun Pt/C/PVDF and Nafion®/PEO is shown in FIG. 25. The Nafion® nanofibers are smooth, while the catalyst containing fibers are rough and porous.

Procedure: Membrane-Electrode-Assembly (MEA) Preparation:

Before incorporation into an MEA, the electrospun mat was annealed at 150° C. for 1 hour in vacuum to crystallize the Nafion® fibers and make then insoluble in water. Catalyst coated membranes (CCMs) were created by hot pressing 5 cm² electrospun electrodes onto the opposing sides of a Nafion® 211 membrane at 140° C. and 4 MPa for 1 minute, after a 10-minute heating period at 140° C. and 0 MPa. The Pt loading of a nanofiber mat was calculated from its total electrode weight and the weight-fraction of Pt/C catalyst in the total volume of the electro spinning inks spun (including the PVDF ink that contained Pt and the Nafion® ink that did not contain Pt). The CCMs were acid-treated in hot 1 M sulfuric acid for 1 hour to extract the PEO from the Nafion®. 5 cm² carbon gas diffusion layers (Sigracet GDL 25 BCH) were physically pressed onto the CCM's anode and cathode to form a MEA (Membrane Electrode Assembly) when placed in the fuel cell test fixture.

MEA Performance Results:

The polarization curve of an MEA with a dual fiber Pt/C/PVDF+Nafion®/PEO cathode is shown in FIG. 26. The anode is a single fiber electrospun mat with Pt/C bound with Nafion® and poly(acrylic acid). The Pt loading of the anode and cathode was the same, at 0.10 mg/cm². The maximum power (the product of current density and voltage) of the MEA was 364 mW/cm² at 80° C. in fully humidified H₂/air at ambient pressure.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

### REFERENCE LIST

[1]. Litster, S. and G. McLean, PEM fuel cell electrodes. Journal of Power Sources, 2004. 130(1-2): p. 61-76.
[2]. Gasteiger, H. A., et al., Activity benchmarks and requirements for Pt, Pt-alloy, and non-Pt oxygen reduction catalysts for PEMFCs. Applied Catalysis B: Environmental, 2005. 56(1-2): p. 9-35.
[3]. Zhang, W. and P. N. Pintauro, High-Performance Nanofiber Fuel Cell Electrodes. ChemSusChem, 2011. 4(12): p. 1753-1757.
[4]. Brodt, M., R. Wycisk, and P. N. Pintauro, Nanofiber Electrodes with Low Platinum Loading for High Power Hydrogen/Air PEM Fuel Cells. Journal of the Electrochemical Society, 2013. 160(8): p. F744-F749.
[5]. Brodt, M., et al., Fabrication, In-Situ Performance, and Durability of Nanofiber Fuel Cell Electrodes. Journal of the Electrochemical Society, 2015. 162(1): p. F84-F91.
[6]. Park, Y. C., et al., Investigation of the corrosion of carbon supports in polymer electrolyte fuel cells using simulated start-up/shutdown cycling. Electrochimica Acta, 2013. 91: p. 195-207.
[7]. Young, A. P., J. Stumper, and E. Gyenge, Characterizing the Structural Degradation in a PEMFC Cathode Catalyst Layer: Carbon Corrosion. Journal of the Electrochemical Society, 2009. 156(8): p. B913-B922.
[8]. Kocha, S. S., Chapter 3—Electrochemical Degradation: Electrocatalyst and Support Durability, in Polymer Electrolyte Fuel Cell Degradation, M. M. Mench, E. C. Kumbur, and T. N. Veziroglu, Editors. 2012, Academic Press: Boston. p. 89-214.
[9]. Mench, M. M., E. C. Kumbur, and T. N. Veziroglu, Polymer Electrolyte Fuel Cell Degradation. 2011: Elsevier Science.
[10]. Parrondo, J., et al., Platinum supported on titanium-ruthenium oxide is a remarkably stable electrocatayst for hydrogen fuel cell vehicles. Proceedings of the National Academy of Sciences, 2014. 111(1): p. 45-50.
[11]. Stassi, A., et al., Oxide-supported PtCo alloy catalyst for intermediate temperature polymer electrolyte fuel cells. Applied Catalysis B: Environmental, 2013. 142-143(0): p. 15-24.
[12]. Kumar, A. and V. K. Ramani, RuO2-SiO2 mixed oxides as corrosion-resistant catalyst supports for polymer electrolyte fuel cells. Applied Catalysis B: Environmental, 2013. 138-139(0): p. 43-50.
[13]. Hara, M., et al., Electrochemical and Raman spectroscopic evaluation of Pt/graphitized carbon black catalyst durability for the start/stop operating condition of polymer electrolyte fuel cells. Electrochimica Acta, 2012. 70(0): p. 171-181.
[14]. Debe, M. K., et al., High voltage stability of nanostructured thin film catalysts for PEM fuel cells. Journal of Power Sources, 2006. 161(2): p. 1002-1011.
[15]. Su, H. N., et al., Optimization of gas diffusion electrode for polybenzimidazole-based high temperature proton exchange membrane fuel cell: Evaluation of polymer binders in catalyst layer. International Journal of Hydrogen Energy, 2013. 38(26): p. 11370-11378.
[16]. Landis, F. A. and R. B. Moore, Blends of a perfluorosulfonate ionomer with poly(vinylidene fluoride): effect of counterion type on phase separation and crystal morphology. Macromolecules, 2000. 33(16): p. 6031-6041.
[17]. Wycisk, R., et al., Electrospinning PFSA+PVDF Nanofibers for Fuel Cell Membrane Fabrication. Meeting Abstracts, 2014. MA2014-02(21): p. 1199.
[18]. Oh, H.-S., et al., Corrosion resistance and sintering effect of carbon supports in polymer electrolyte membrane fuel cells. Electrochimica Acta, 2009. 54(26): p. 6515-6521.
[19]. Ballengee, J. B. and P. N. Pintauro, Morphological Control of Electrospun Nafion Nanofiber Mats. Journal of the Electrochemical Society, 2011. 158(5): p. B568-B572.
[20]. Ohma, A., et al., Membrane and Catalyst Performance Targets for Automotive Fuel Cells by FCCJ Membrane, Catalyst, MEA WG. ECS Transactions, 2011. 41(1): p. 775-784.
[21]. Mackey, M., et al., Confined crystallization of PVDF and a PVDF-TFE copolymer in nanolayered films. Journal of Polymer Science Part B: Polymer Physics, 2011. 49(24): p. 1750-1761.
[22]. Broka, K. and P. Ekdunge, Oxygen and hydrogen permeation properties and water uptake of Nafion® 117 membrane and recast film for PEM fuel cell. Journal of Applied Electrochemistry, 1997. 27(2): p. 117-123.
[23]. Xu, H., et al., Effect of Elevated Temperature and Reduced Relative Humidity on ORR Kinetics for PEM Fuel Cells. Journal of the Electrochemical Society, 2005. 152(9): p. A1828-A1836.
[24]. Song, W., et al., A new hydrophobic thin film catalyst layer for PEMFC. Solid State Ionics, 2010. 181(8-10): p. 453-458.
[25]. Kang, J. and J. Kim, Membrane electrode assembly degradation by dry/wet gas on a PEM fuel cell. International Journal of Hydrogen Energy, 2010. 35(23): p. 13125-13130.
[26]. Sinha, P. K., et al., Performance of Nano Structured Thin Film (NSTF) Electrodes under Partially-Humidified Conditions. Journal of the Electrochemical Society, 2011. 158(7): p. B831-B840.
[27]. Peron, J., et al., Properties of Nafion® NR-211 membranes for PEMFCs. Journal of Membrane Science, 2010. 356(1-2): p. 44-51.
[28]. Seo, D., et al., Physical degradation of MEA in PEM fuel cell by on/off operation under nitrogen atmosphere. Korean Journal of Chemical Engineering, 2010. 27(1): p. 104-109.
[29]. Selvaganesh, S. V., et al., Graphitic Carbon as Durable Cathode-Catalyst Support for PEFCs. Fuel Cells, 2011. 11(3): p. 372-384.
[30]. Janssen, G. J. M. and E. F. Sitters, Performance of thin-film cathodes for proton-exchange-membrane fuel cells based on high-surface-area carbon supports. Journal of Power Sources, 2007. 171(1): p. 8-17.
[31]. Ogasawara, H., et al., Double Role of Water in the Fuel Cell Oxygen Reduction Reaction. ECS Transactions, 2008. 16(2): p. 1385-1394.
[32]. Kim, T., et al., Development of catalytically active and highly stable catalyst supports for polymer electrolyte membrane fuel cells. Journal of Power Sources, 2015. 273(0): p. 761-774.
[33]. Bi, W. and T. Fuller, Temperature Effects on PEM Fuel Cells Pt/C Catalyst Degradation. ECS Transactions, 2007. 11(1): p. 1235-1246.
[34]. Neyerlin, K. C., et al., Effect of Relative Humidity on Oxygen Reduction Kinetics in a PEMFC. Journal of the Electrochemical Society, 2005. 152(6): p. A1073-A1080.
[35]. Yli-Rantala, E., et al., Graphitised Carbon Nanofibres as Catalyst Support for PEMFC. Fuel Cells, 2011. 11(6): p. 715-725.
[36]. Spernjak, D., et al., Characterization of Carbon Corrosion in a Segmented PEM Fuel Cell. ECS Transactions, 2011. 41(1): p. 741-750.
[37]. Maass, S., et al., Carbon support oxidation in PEM fuel cell cathodes. Journal of Power Sources, 2008. 176(2): p. 444-451.
[38]. Kreitmeier, S., A. Wokaun, and F. N. Büchi, Local Catalyst Support Degradation during Polymer Electrolyte Fuel Cell Start-Up and Shutdown. Journal of the Electrochemical Society, 2012. 159(11): p. F787-F793.
[39]. Lee, T. K., et al., Improved durability of Pt/CNT catalysts by the low temperature self-catalyzed reduction for the PEM fuel cells. International Journal of Hydrogen Energy, 2012. 37(23): p. 17992-18000.
[40]. Hashimasa, Y., et al., Verification of Durability Test Methods of an MEA for Automotive Application. ECS Transactions, 2013. 50(2): p. 723-732.
[41]. Guétaz, L., S. Escribano, and O. Sicardy, Study by electron microscopy of proton exchange membrane fuel cell membrane-electrode assembly degradation mechanisms: Influence of local conditions. Journal of Power Sources, 2012. 212(0): p. 169-178.

What is claimed is:

1. A method of forming a membrane-electrode-assembly (MEA) for an electrochemical device, comprising:
providing a first solution and a second solution, wherein the first solution comprises a first catalyst, at least one first charged polymer, and at least one first uncharged polymer, and wherein the second solution comprises a second catalyst, at least one second charged polymer, and at least one second functional polymer;
electro spinning the first solution and the second solution to form a first nanofiber mat and a second nanofiber mat, respectively;
providing a membrane having a first side and an opposite, second side;
pressing the first nanofiber mat on the first side of the membrane as a cathode, and pressing the second nanofiber mat on the second side of the membrane as an anode, so as to form a catalyst coated membrane (CCM); and
processing the CCM to form the MEA.

2. The method of claim 1, wherein the at least one first uncharged polymer comprises a repeat unit having a formula of 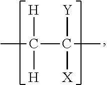
and each of X and Y is a non-hydroxyl group.

3. The method of claim 1, wherein the first solution further comprises as least one first functional polymer to assist electro spinning of the first solution, or to improve at least one property of the cathode.

4. The method of claim 1, wherein each of the first catalyst and the second catalyst is a platinum/carbon (Pt/C) catalyst or a Pt-alloy catalyst.

5. The method of claim 4, wherein at least one of the first solution and the second solution is selected from:
a composition comprising Pt/Co catalyst, a perfluorosulfonic acid (PFSA) polymer, and poly(acrylic acid) (PAA);
a composition comprising Pt/Ni catalyst, a PFSA polymer, and PAA;
a composition comprising Pt/Co catalyst, a PFSA polymer, and poly(vinylidene fluoride) (PVDF); or
a composition comprising Pt/Ni catalyst, a PFSA polymer, and PVDF.

6. The method of claim 5, wherein the PFSA polymer is Nafion®.

7. The method of claim 1, wherein catalyst loading in the cathode and the anode is in a range of about 0.10-0.50 mg/cm².

8. The method of claim 1, wherein the membrane is a perfluorosulfonic acid membrane like Nafion® 211 membrane.

9. The method of claim 1, wherein each of the at least one first charged polymer and the at least one second charged polymer is a PFSA polymer or a perfluoroimide-acid (PFIA) polymer.

10. The method of claim 9, wherein each of the at least one first charged polymer and the at least one second charged polymer is Nafion®.

11. The method of claim 10, wherein the at least one first uncharged polymer is PVDF, and the at least one second functional polymer is PAA.

12. The method of claim 11, wherein an amount of the PVDF in the first solution is in a range of about 20%-80% by weight of a total amount of the Nafion® and the PVDF in the first solution.

13. The method of claim 12, wherein the first catalyst is platinum/carbon (Pt/C) catalyst, and wherein the first solution is formed by:
wetting the first catalyst with dimethylformamide (DMF) to form a first mixture;
adding tetrahydrofuran (THF) to the first mixture to form a second mixture;
adding Nafion® to the second mixture to form a third mixture and sonicating the third mixture; and
adding PVDF to the third mixture, and stirring to form the first solution.

14. The method of claim 13, wherein the second catalyst is Pt/C catalyst, and wherein the second solution is formed by:
wetting the second catalyst with water to form a fourth mixture;
adding isopropanol (IPA) to the fourth mixture to form a fifth mixture;
adding Nafion® to the fifth mixture to form a sixth mixture and sonicating the sixth mixture; and
adding PAA to the sixth mixture, and stirring to form the second solution.

15. The method of claim 1, wherein the steps of processing the CCM to form the MEA comprises:
pressing a carbon gas diffusion layer on each of the cathode and the anode of the CCM.

16. A fuel cell comprising the MEA of claim 1.

17. A membrane-electrode-assembly (MEA) for an electrochemical device, comprising:
a polymer electrolyte membrane having a first side and an opposite, second side;
a cathode of a first nanofiber mat attached to the first side of the polymer electrolyte membrane, wherein the first nanofiber mat is formed of a first catalyst, at least one first charged polymer and at least one first uncharged polymer; and
an anode of a second nanofiber mat attached to the second side of the polymer electrolyte membrane, wherein the second nanofiber mat is formed of a second catalyst, at least one second charged polymer and at least one second functional polymer.

18. The MEA of claim 17, wherein the at least one first uncharged polymer comprises a repeat unit having a formula of 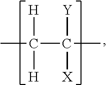
and each of X and Y is a non-hydroxyl group

19. The MEA of claim 17, wherein the first nanofiber mat is formed of, in addition to the first catalyst, the at least one first charged polymer and the at least one first uncharged polymer, at least one first functional polymer, wherein the at least one first functional polymer is capable of assisting electro spinning to form the first nanofiber mat, or is capable of improving at least one property of the cathode.

20. The MEA of claim 17, further comprising a first carbon gas diffusion layer disposed on an outer surface of the cathode and a second carbon gas diffusion layer disposed on an outer surface of the anode.

21. The MEA of claim 17, wherein each of the at least one first charged polymer and the at least one second charged polymer is a perfluorosulfonic acid (PFSA) ionomer or a perfluoroimide-acid polymer (PFIA) ionomer.

22. The MEA of claim 21, wherein the at least one first charged polymer and the at least one second charged polymer are Nafion®.

23. The MEA of claim 22, wherein the first catalyst and the second catalyst are platinum/carbon (Pt/C) catalyst, the polymer electrolyte membrane is a Nafion® 211 membrane, the at least one first uncharged polymer is poly(vinylidene fluoride) (PVDF) or a copolymer thereof, and the at least one second functional polymer is poly(acrylic acid) (PAA) which functions as a carrier for electro spinning.

24. The MEA of claim 23, wherein an amount of the PVDF in the cathode is in a range of about 20%-80% by weight of a total amount of the Nafion® and the PVDF in the cathode.

25. The MEA of claim 23, wherein Pt loading in the cathode and the anode is in a range of about 0.10-0.50 mg/cm².

26. The MEA of claim 17, wherein at least one of the first nanofiber mat and the second nanofiber mat comprises:
Pt/Co catalyst, a PFSA polymer, and PAA;
Pt/Ni catalyst, a PFSA polymer, and PAA;
Pt/Co catalyst, a PFSA polymer, and PVDF; or
Pt/Ni catalyst, a PFSA polymer, and PVDF.

27. The MEA of claim 26, wherein the PFSA polymer is Nafion®.

28. A fuel cell comprising the MEA of claim 17.

29. A method of forming a membrane-electrode-assembly (MEA) for an electrochemical device, comprising:
providing a first ink and a second ink, wherein the first ink is formed by mixing Nafion® and poly(ethylene oxide (PEO) in a 2:1 n-propanol/water solution, and the second ink is formed by mixing Pt/C catalyst and PVDF in a 3:7 DMF/acetone solution;
electrospinning, separately and simultaneously, the first ink and the second ink to form a dual fiber mat comprising first polymer fibers formed from the first ink and second polymer fibers formed from the second ink;
annealing the dual fiber mat at about 150° C. for about 1 hour in vacuum, and heating at about 140° C. for about 10 minutes in vacuum;
pressing the annealed and heated dual fiber mat to opposing sides of a Nafion® 211 membrane at about 140° C. for about 1 minutes under 4 MPa as cathode and anode to form CCM;
treating the CCM using 1M sulfuric acid for 1 hour so as to extract the PEO; and
pressing a carbon gas diffusion layer on each of the cathode and the anode to form the MEA.

30. The method of claim 29, wherein a ratio between an amount of the Nafion® and the PEO is about 100:1 by weight, and a ratio between an amount of the catalyst and an amount of the PVDF is about 3:1 by weight.

31. The method of claim 29, wherein a Pt loading in the cathode and the anode is in a range of about 0.10-0.50 mg/cm².
